(19) United States
(12) Patent Application Publication
(10) Pub. No.: US 2013/0071651 A1
(43) Pub. Date: Mar. 21, 2013

(54) HEAT-RAY SHIELDING MATERIAL

(71) Applicants: Shinya Hakuta, Ashigarakami-gun (JP); Takeharu Tani, Ashigarakami-gun (JP); Naoharu Kiyoto, Ashigarakami-gun (JP)

(72) Inventors: Shinya Hakuta, Ashigarakami-gun (JP); Takeharu Tani, Ashigarakami-gun (JP); Naoharu Kiyoto, Ashigarakami-gun (JP)

(73) Assignee: FUJIFILM CORPORATION, Tokyo (JP)

(21) Appl. No.: 13/701,309

(22) PCT Filed: Apr. 20, 2011
(86) PCT No.: PCT/JP2011/059764

§ 371 Date: Nov. 30, 2012

(30) Foreign Application Priority Data
Jun. 3, 2010 (JP) 2010-127684

(51) Int. Cl. G02B 5/20

(52) U.S. Cl. CPC G02B 5/206
USPC 428/333

(57) ABSTRACT

A heat-ray shielding material including: two or more metal particle-containing layers each containing at least one kind of metal particles; and one or more transparent dielectric layers, the heat-ray shielding material having a lamination structure where the metal particle-containing layers and the dielectric layers are alternatingly laminated, wherein at least one of the transparent dielectric layers has an optical thickness (nd) which satisfies the following expression (1) with respect to wavelength λ1 at which reflectance of the transparent dielectric layer is minimum:

{(2m+1)×(λ1/4)}−{(λ1/4)×0.25}<nd<{(2m+1)×(λ1/4)}+{(λ1/4)×0.25} Expression (1)
where m is an integer of 0 or greater, λ1 is a wavelength at which the reflectance is minimum, n is a refractive index of the dielectric layer and d is a thickness (nm) of the dielectric layer.

### TECHNICAL FIELD

The present invention relates to a heat-ray shielding material excellent in reflectance with respect to infrared rays such as near-infrared rays and excellent in transmittance with respect to visible light.

### BACKGROUND ART

In recent years, as one of energy saving measures to reduce carbon dioxide emissions, there have been developed heat-ray shielding materials for windows of buildings and automobiles. From the viewpoint of heat ray-shielding properties (solar heat gain coefficient), materials of heat ray reflective type which re-radiate no heat are more desirable than heat absorbing materials which re-radiate absorbed light into rooms (in an amount of about 1/3 of the solar radiation energy absorbed) and various techniques have been proposed.

For example, Ag metal thin films are generally used as heat ray-reflecting materials because of their high reflectance.

However, Ag metal thin films reflect not only visible light and heat rays but also radio waves, and thus have problems with their low visible light transmittance and low radio wave transmittance.

In order to increase the visible light transmittance, for example, Low-E-glass (e.g., a product of Asahi Glass Co., Ltd.) which utilizes an Ag—ZnO-multilayered film has been proposed and widely adopted in buildings.

However, Low-E glass has a problem with its low radio wave transmittance because the Ag metal thin film is formed on a surface of the glass.

In order to solve the above problems, for example, there has been island-shaped Ag particle-attached glass to which radio wave transmittance has been imparted. There has been proposed a glass where granular Ag is formed by annealing an Ag thin film which has been formed through vapor deposition (see PTL 1).

However, in this proposal, since granular Ag is formed by annealing, difficulty is encountered in controlling the size and the shape of particles and the area ratio thereof, in controlling the reflection wavelength and reflection band of heat rays and in increasing the visible light transmittance.

Furthermore, there have been proposed filters using Ag flat particles as an infrared ray-shielding filter (see PTLs 2 to 6).

However, these proposals are each intended for use in plasma display panels. Hence, they use particles of small volume in order to improve the absorbability of light in the infrared wavelength region and they do not use the Ag flat particles as a material to shield heat rays (a material that reflects heat rays).

Therefore, there have been proposed a reflective film that selectively reflects light of wavelength λ, the reflective film having a lamination structure where a transparent thin film substantially transparent to light of wavelength λ and a metal layer are alternatingly periodically laminated (see PTL 7) and a glass laminate that reflects light having a wavelength of the infrared region, the glass laminate containing a first glass plate, a second glass plate and infrared ray-shielding particles disposed therebetween (see PTL 8).

However, these proposals have a problem that the film or laminate reflects light having a wavelength close to that of light intended to reflect and thus cannot reflect light of a specific wavelength. As a result, they reflect visible light rays close to the infrared region to problematically become a mirror. Also, in these proposals, it is not possible to select the wavelength intended to reflect.

As described above, strong demand has been arisen for rapid development of a heat-ray shielding material excellent in reflectance with respect to infrared rays such as near-infrared rays and excellent in transmittance with respect to visible light.

### CITATION LIST

### Patent Literature

PTL 1: Japanese Patent (JP-B) No. 3454422
PTL 2: Japanese Patent Application Laid-Open (JP-A) No. 2007-108536
PTL 3: JP-A No. 2007-178915
PTL 4: JP-A No. 2007-138249
PTL 5: JP-A No. 2007-138250
PTL 6: JP-A No. 2007-154292
PTL 7: JP-A No. 2008-89821
PTL 8: International Publication No. WO2007/020791

### SUMMARY OF INVENTION

### Technical Problem

The present invention aims to solve the above existing problems and achieve the following objects. That is, the present invention aims to provide a heat-ray shielding material excellent in reflectance with respect to infrared rays such as near-infrared rays and excellent in transmittance with respect to visible light.

### Solution to Problem

Means for solving the above problems are as follows.

<1> A heat-ray shielding material including:

two or more metal particle-containing layers each containing at least one kind of metal particles; and

one or more transparent dielectric layers,

the heat-ray shielding material having a lamination structure where the metal particle-containing layers and the dielectric layers are alternatingly laminated,

wherein at least one of the transparent dielectric layers has an optical thickness (nd) which satisfies the following expression (1) with respect to wavelength λ1 at which reflectance of the transparent dielectric layer is minimum:

{(2m+1)×(λ1/4)}−{(λ1/4)×0.25}<nd<{(2m+1)×(λ1/4)}+{(λ1/4)×0.25} Expression (1)

where m is an integer of 0 or greater, λ1 is a wavelength at which the reflectance is minimum, n is a refractive index of the dielectric layer and d is a thickness (nm) of the dielectric layer.

<2> The heat-ray shielding material according to <1>, wherein the metal particles contain flat metal particles each having a substantially hexagonal shape or a substantially disc shape or both thereof in an amount of 60% by number or more.

<3> The heat-ray shielding material according to <1> or <2>, wherein among the two or more metal particle-containing layers, the metal particle-containing layer closest to a surface of the heat-ray shielding material through which solar radiation enters has the highest reflectance.

<4> The heat-ray shielding material according to any one of <1> to <3>, wherein m in the expression (1) is 0.

<5> The heat-ray shielding material according to any one of <1> to <4>, wherein the metal particles contain at least silver.

<6> The heat-ray shielding material according to any one of <1> to <5>, wherein the metal particles are coated with a high-refractive-index material.

<7> The heat-ray shielding material according to any one of <1> to <6>, wherein the heat-ray shielding material has a solar heat gain coefficient of 70% or lower.

<8> The heat-ray shielding material according to any one of <1> to <7>, wherein the wavelength λ1 at which the reflectance is minimum is 380 nm to 780 nm.

<9> The heat-ray shielding material according to any one of <1> to <8>, wherein the metal particle-containing layer has the minimum transmittance at a wavelength of 600 nm to 2,000 nm.

<10> The heat-ray shielding material according to any one of <1> to <9>, wherein the heat-ray shielding material has a transmittance of 60% or higher with respect to visible light rays.

<11> The heat-ray shielding material according to any one of <1> to <10>, wherein the dielectric layer has a thickness of 5 nm to 5,000 nm.

### Advantageous Effects of Invention

The present invention can provide a heat-ray shielding material excellent in reflectance with respect to infrared rays such as near-infrared rays and excellent in transmittance with respect to visible light. This can solve the above existing problems and achieve the above objects.

### BRIEF DESCRIPTION OF DRAWINGS

FIG. 1A is a schematic perspective view of a substantially disc-shaped flat particle which is one exemplary flat particle contained in a heat ray-shielding material of the present invention, where the horizontal double-sided arrow is the diameter thereof and the vertical double-sided arrow is the thickness thereof.

FIG. 1B is a schematic perspective view of a substantially hexagonal flat particle which is one exemplary flat particle contained in a heat ray-shielding material of the present invention, where the horizontal double-sided arrow is the diameter thereof and the vertical double-sided arrow is the thickness thereof.

FIG. 2 is a schematic plan view of one embodiment where flat particles are arranged in a heat ray-shielding material of the present invention.

FIG. 3A is one exemplary schematic cross-sectional view of a metal particle-containing layer containing flat metal particles in a heat ray-shielding material of the present invention, where the flat metal particles are present in an ideal state.

FIG. 3B is one exemplary schematic cross-sectional view of a metal particle-containing layer containing flat metal particles in a heat ray-shielding material of the present invention, which is for explaining angles (θ) formed between a surface of a substrate and planes of flat particles.

FIG. 3C is one exemplary schematic cross-sectional view of a metal particle-containing layer containing flat metal particles in a heat ray-shielding material of the present invention, which illustrates a region where the flat metal particles are present in a depth direction of the metal particle-containing layer of the heat ray-shielding material.

FIG. 4 is a schematic cross-sectional view of one example of a heat-ray shielding material of the present invention.

FIG. 5 is a SEM image of the heat-ray shielding material of Example 1 which is observed at a magnification of ×20,000.

FIG. 6A is a graph of spectrometric spectra of the heat-ray shielding material of Example 4, where “A” is an absorption spectrum, “T” is a transmission spectrum and “R” is a reflection spectrum.

FIG. 6B is a graph of spectrometric spectra of the heat-ray shielding material of Comparative Example 6, where “A” is an absorption spectrum, “T” is a transmission spectrum and “R” is a reflection spectrum.

FIG. 6C is a graph of spectrometric spectra of the heat-ray shielding material of Example 1, where “A” is an absorption spectrum, “T” is a transmission spectrum and “R” is a reflection spectrum.

FIG. 6D is a graph of spectrometric spectra of the heat-ray shielding material of Comparative Example 3, where “A” is an absorption spectrum, “T” is a transmission spectrum and “R” is a reflection spectrum.

### DESCRIPTION OF EMBODIMENTS

### Heat-Ray Shielding Material

A heat-ray shielding material of the present invention includes a metal particle-containing layer containing at least one kind of metal particles, and a transparent dielectric layer; and, if necessary, further includes other members.

Also, the heat-ray shielding material of the present invention has a lamination structure where two or more of the metal particle-containing layer and one or more of the dielectric layer are alternatingly laminated.

### <Metal Particle-Containing Layer>

The metal particle-containing layer is not particularly limited and may be appropriately selected depending on the intended purpose, so long as it is a layer containing at least one kind of metal particles and formed on a substrate.

### —Metal Particles—

The metal particles are not particularly limited and may be appropriately selected depending on the intended purpose. Examples thereof include flat particles of a metal (hereinafter may be referred to as “flat metal particles”), granular particles, cubic particles, hexagonal particles, octahedral particles and rod-like particles, with flat metal particles being particularly preferred.

The state of the metal particles in the metal particle-containing layer is not particularly limited and may be appropriately selected depending on the intended purpose. It is preferably a state where the metal particles are located substantially horizontally with respect to the surface of the substrate. Examples of the state include a state where the substrate is substantially in contact with the metal particles, and a state where the substrate and the metal particles are arranged a certain distance apart in a depth direction of the heat ray-shielding material.

The size of the metal particles is not particularly limited and may be appropriately selected depending on the intended purpose. For example, the metal particles have an average circle-equivalent diameter of 500 nm or smaller.

The material for the metal particles is not particularly limited and may be appropriately selected depending on the intended purpose. Preferred are silver, gold, aluminum, copper, rhodium, nickel and platinum, from the viewpoint of high reflectance with respect to heat rays (infrared rays). Particularly preferably, the metal particles contain silver.

### —Flat Metal Particles—

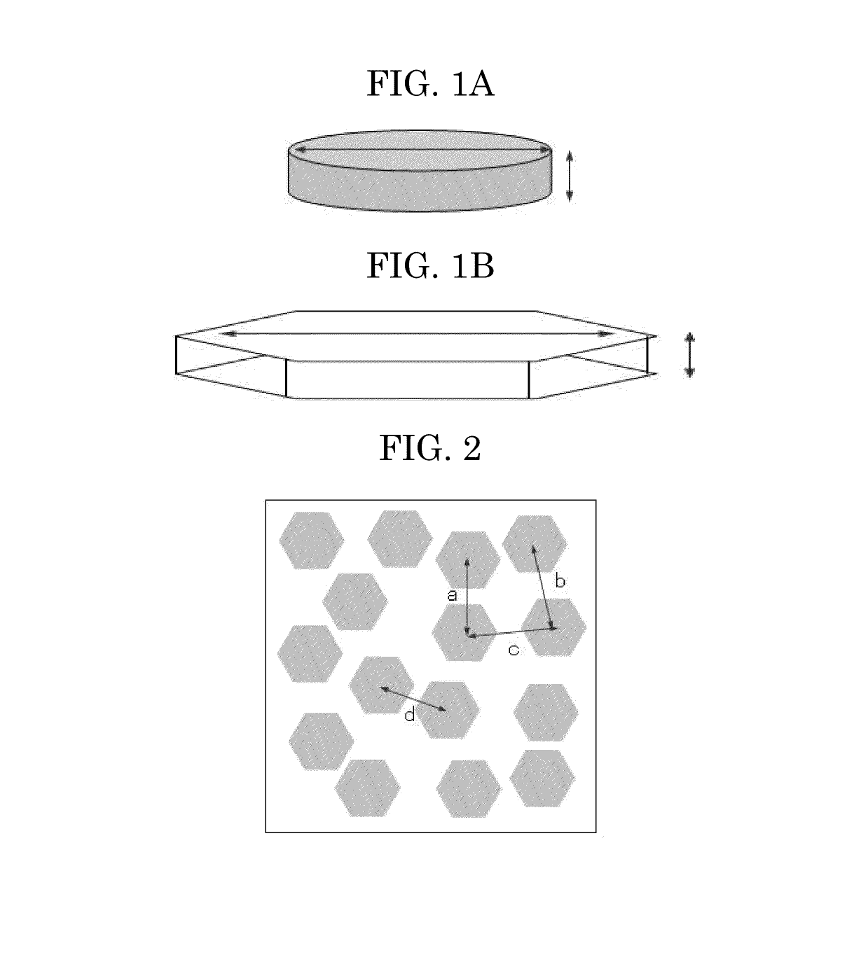

The flat metal particle is not particularly limited and may be appropriately selected depending on the intended purpose so long as it is composed of two flat planes (see FIGS. 1A and 1B). The flat metal particle has, for example, a substantially hexagonal shape, a substantially disc shape or a substantially triangular shape. Among these shapes, the flat metal particle particularly preferably has a substantially hexagonal shape or a substantially disc shape, from the viewpoint of high visible light transmittance. Also, the flat metal particle may be coated with a binder.

The above flat plane refers to a plane containing the diameter as illustrated in FIGS. 1A and 1B.

The substantially disc-shape is not particularly limited and may be appropriately selected depending on the intended purpose as long as when the flat metal particle is observed from above the flat plane (from the side of the flat plane) under a transmission electron microscope (TEM), the observed shape is a round shape without angular corners.

The substantially hexagonal shape is not particularly limited and may be appropriately selected depending on the intended purpose as long as when observed above the flat plane (from the side of the flat plane) under a transmission electron microscope (TEM), the observed shape is a substantially hexagonal. The angles of the hexagonal shape may be acute or obtuse. From the viewpoint of reducing absorption of light having a wavelength in the visible light region, the angles of the hexagonal shape are preferably obtuse. The degree of the obtuseness is not particularly limited and may be appropriately selected depending on the intended purpose.

Among the metal particles present in the metal particle-containing layer, the amount of the flat metal particles having a substantially hexagonal shape and/or a substantially disc shape is not particularly limited and may be appropriately selected depending on the intended purpose. It is preferably 60% by number or more, more preferably 65% by number or more, particularly preferably 70% by number or more, relative to the total number of the metal particles. When the rate of the flat metal particles is less than 60% by number, the visible light transmittance may decrease.

The amount of the flat metal particles having a substantially hexagonal shape and/or a substantially disc shape can be measured through observation under a transmission electron microscope (TEM) or a scanning electron microscope (SEM).

### [Plane Orientation]

In one embodiment of the heat ray-shielding material of the present invention, the flat planes of the flat metal particles are oriented at a predetermined range with respect to the surface of the substrate.

The state of the flat metal particles is not particularly limited and may be appropriately selected depending on the intended purpose. From the viewpoint of increasing the reflectance with respect to heat rays, preferably, the flat metal particles are located substantially horizontally with respect to the surface of the substrate.

The plane orientation is not particularly limited and may be appropriately selected depending on the intended purpose so long as the flat planes of the flat metal particles are in substantially parallel with at a predetermined range with respect to the surface of the substrate. The angle in the plane orientation is preferably 0° to ±30°, more preferably 0° to ±20°.

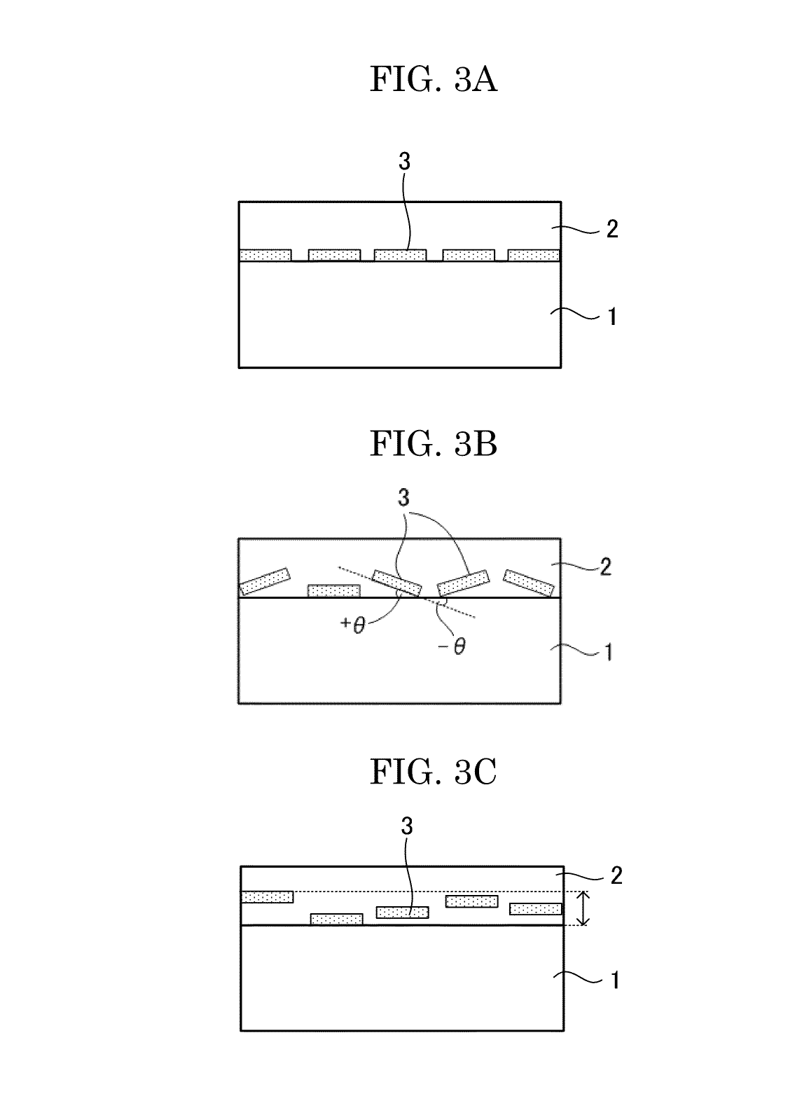

Here, FIGS. 3A to 3C are schematic cross-sectional views each exemplarily illustrating the state of the flat metal particles contained in the metal particle-containing layer of the heat ray-shielding material of the present invention. FIG. 3A illustrates the most ideal state of the flat metal particles 3 in the metal particle-containing layer 2. FIG. 3B is an explanatory view for an angle (±θ) formed between the surface of the substrate 1 and the plane of the flat metal particle 3. FIG. 3C is an explanatory view for a region where the flat metal particles are present in the metal particle-containing layer 2 in a depth direction of the heat ray-shielding material.

In FIG. 3B, the angle (±θ) formed between the surface of the substrate 1 and the flat plane of the flat metal particle 3 or an extended line of the flat plane thereof corresponds to the predetermined range in the plane orientation. In other words, the plane orientation refers to a state where when a cross-section of the heat ray-shielding material is observed, a tilt angle (±θ) illustrated in FIG. 3B is small. In particular, FIG. 3A illustrates a state where the flat planes of the flat metal particles 3 are in contact with the surface of the substrate 1; i.e., a state where θ is 0°. When the angle formed between the surface of the substrate 1 and the plane of the flat metal particle 3; i.e., θ in FIG. 3B, exceeds ±30°, the reflectance of the heat ray-shielding material with respect to light having a specific wavelength (e.g., a wavelength from the near-infrared region to a longer wavelength region of the visible light region) may decrease, and the haze may increase.

From the viewpoint of increasing resonance reflectance, the thickness of the region where the metal particles are present (i.e., thickness of the particle-containing region f(λ) which corresponds to a region shown by the double-sided arrow in FIG. 3C) is preferably 2,500/(4n) nm or small, more preferably 7001(4n) nm or small, particularly preferably 400/(4n) nm or small, where n is an average refractive index of the surrounding region of the metal particles.

When the above thickness is larger than 2,500/(4n) nm, the haze may increase to reduce the amplification effect of the amplitudes of reflected waves due to their phases at the interfaces of the metal particle-containing layer on the upper side (on the opposite side to the substrate) and on the lower side (on the substrate side) of the heat-ray shielding material, so that the reflectance at a resonance wavelength may greatly decrease.

### [Evaluation of Plane Orientation]

The method for evaluating whether or not the flat planes of the flat metal particles are plane-oriented with respect to the surface of the substrate is not particularly limited and may be appropriately selected depending on the intended purpose. Examples thereof include a method including preparing an appropriate cross-sectional piece and observing the substrate and the flat metal particles in the piece for evaluation. In one specific method, the heat ray-shielding material is cut with a microtome or a focused ion beam (FIB) to prepare a cross-sectional sample or a cross-sectional piece of the heat ray-shielding material; the thus-prepared sample or piece is observed under various microscopes (e.g., a field emission scanning electron microscope (FE-SEM)); and the obtained images are used for evaluation.

In the heat ray-shielding material of the present invention, when the binder covering the flat metal particles is swelled with water, the cross-sectional sample or cross-sectional piece may be prepared by freezing the heat ray-shielding material in liquid nitrogen and by cutting the resultant sample with a diamond cutter mounted to a microtome. In contrast, when the binder covering the flat metal particles in the heat ray-shielding material is not swelled with water, the cross-sectional sample or piece may be prepared directly.

The method for observing the above-prepared cross-sectional sample or piece is not particularly limited and may be appropriately selected depending on the intended purpose so long as it can determine whether or not the flat planes of the flat metal particles are plane-oriented with respect to the surface of the substrate in the sample. The observation can be performed under, for example, a FE-SEM, a TEM and an optical microscope. The cross-sectional sample may be observed under a FE-SEM and the cross-sectional piece may be observed under a TEM. When the FE-SEM is used for evaluation, the FE-SEM preferably has a spatial resolution with which the shapes of the flat metal particles and the tilt angles (±θ illustrated in FIG. 3B) can be clearly observed.

### [Average Circle-Equivalent Diameter and Particle Size Distribution of Average Circle-Equivalent Diameter]

The average circle-equivalent diameter of the flat metal particles is not particularly limited and may be appropriately selected depending on the intended purpose, but is preferably 10 nm to 5,000 nm, more preferably 30 nm to 1,000 nm, particularly preferably 70 nm to 500 nm.

When the average circle-equivalent diameter is smaller than 10 nm, the aspect ratio becomes small and their shapes may tend to be spherical. In addition, the peak wavelength of the transmission spectrum may be 500 nm or shorter.

When the average circle-equivalent diameter is greater than 5,000 nm, the haze (light scattering) increases, so that the transparency of the substrate may be impaired.

Here, the term “average circle-equivalent diameter” means an average value of the primary plane diameters (maximum lengths) of 200 flat metal particles randomly selected from the images obtained by observing metal particles under a TEM.

Two or more kinds of metal particles having different average circle-equivalent diameters may be incorporated into the metal particle-containing layer. In this case, there may be two or more peaks of the average circle-equivalent diameter of the metal particles. In other words, the metal particles may have two average circle-equivalent diameters.

In the heat ray-shielding material of the present invention, the coefficient of variation in the particle size distribution of the flat metal particles is not particularly limited and may be appropriately selected depending on the intended purpose, but is preferably 30% or lower, more preferably 10% or lower.

When the coefficient of variation is higher than 30%, the wavelength region of heat rays reflected by the heat ray-shielding material may become broad.

Here, the coefficient of variation in the particle size distribution of the flat metal particle is a value (%) which is obtained, for example, by plotting the distribution range of the particle diameters of the 200 flat metal particles selected in the above-described manner to determine a standard deviation of the particle size distribution and by dividing the standard deviation by the above-obtained average value (average circle-equivalent diameter) of the primary plane diameters (maximum lengths).

### [Aspect Ratio]

The aspect ratio of the flat metal particles is not particularly limited and may be appropriately selected depending on the intended purpose. The aspect ratio thereof is preferably 2 to 80, more preferably 4 to 60, since high reflectance can be obtained from a longer wavelength region of the visible light region to the near-infrared region.

When the aspect ratio is less than 2, the reflection wavelength is shorter than 600 nm. Whereas when the aspect ratio is more than 80, the reflection wavelength is longer than 2,000 nm. In both cases, sufficient heat-ray reflectivity cannot be obtained in some cases.

The aspect ratio refers to a value obtained by dividing the average circle-equivalent diameter of the flat metal particles by an average particle thickness of the flat metal particles. The average particle thickness corresponds to the interdistance of the flat planes of the flat metal particles as illustrated in, for example, FIGS. 1A and 1B, and can be measured with an atomic force microscope (AFM).

The method for measuring the average particle thickness with the AFM is not particularly limited and may be appropriately selected depending on the intended purpose. In one exemplary method, a particle dispersion liquid containing flat metal particles is dropped on a glass substrate, followed by drying, to thereby measure the thickness of one particle.

[Region where Flat Metal Particles are Present]

In the heat ray-shielding material of the present invention, as illustrated in FIG. 3C, the metal particle-containing layer 2 preferably exists within a range of (λ/n)/4 in a depth direction from the horizontal surface of the heat ray-shielding material, where λ is a plasmon resonance wavelength of the metal forming the flat metal particles 3 contained in the metal particle-containing layer 2 and n is a refractive index of the medium of the metal particle-containing layer 2. When the metal particle-containing layer 2 exists in a broader range than this range, the amplification effect of the amplitudes of reflected waves due to their phases at the interfaces of the metal particle-containing layer on the upper side (on the opposite side to the substrate) and on the lower side (on the substrate side) of the heat-ray shielding material, so that the visible light transmittance and the maximum heat-ray reflectance may decrease.

The plasmon resonance wavelength λ of the metal forming the flat metal particles contained in the metal particle-containing layer is not particularly limited and may be appropriately selected depending on the intended purpose. The plasmon resonance wavelength λ thereof is preferably 400 nm to 2,500 nm from the viewpoint of obtaining heat-ray reflectivity. More preferably, the plasmon resonance wavelength λ thereof is 700 nm to 2,500 nm from the viewpoint of reducing haze (light scattering) with respect to visible light to thereby obtain visible light transmittance.

The medium of the metal particle-containing layer is not particularly limited and may be appropriately selected depending on the intended purpose. Examples thereof include polyvinylacetal resins, polyvinylalcohol resins, polyvinylbutyral resins, polyacrylate resins, polymethyl methacrylate resins, polycarbonate resins, polyvinyl chloride resins, saturated polyester resins, polyurethane resins, polymers such as naturally occurring polymers (e.g., gelatin and cellulose) and inorganic compounds (e.g., silicon dioxide and aluminum oxide).

The refractive index n of the medium is not particularly limited and may be appropriately selected depending on the intended purpose, but is preferably 1.4 to 1.7.

### [Area Ratio of Flat Metal Particles]

When A and B are respectively an area of the substrate and the total value of areas of the flat metal particles when the heat ray-shielding material is viewed from above of the heat-ray shielding material, the area ratio of (B/A)×100 is preferably 15% or higher, more preferably 20% or higher.

When the area ratio is lower than 15%, the maximum reflectance with respect to heat rays decreases, so that satisfactory heat-shielding effects cannot be obtained in some cases.

The above area ratio can be measured, for example, as follows. Specifically, the heat ray-shielding material is observed from above of the substrate thereof under a SEM or an AFM (atomic force microscope) and the resultant image is subjected to image processing.

### [Average Interparticle Distance of Flat Metal Particles in the Horizontal Direction]

In the metal particle-containing layer, the average interparticle distance of the flat metal particles neighboring in the horizontal direction is preferably ununiform (random) from the viewpoint of obtaining visible light transmittance. When the average interparticle distance thereof is not random; i.e., uniform, diffraction of visible light rays occurs, so that its transmittance may decrease.

Here, the average interparticle distance of the flat metal particles in the horizontal direction refers to an average value of interparticle distances between two neighboring particles. Also, the description “the average interparticle distance is random” means that “there is no significant local maximum point except for the origin in a two-dimensional autocorrelation of brightness values when binarizing a SEM image containing 100 or more of flat metal particles.”

### [Distance Between Neighboring Metal Particle-Containing Layers]

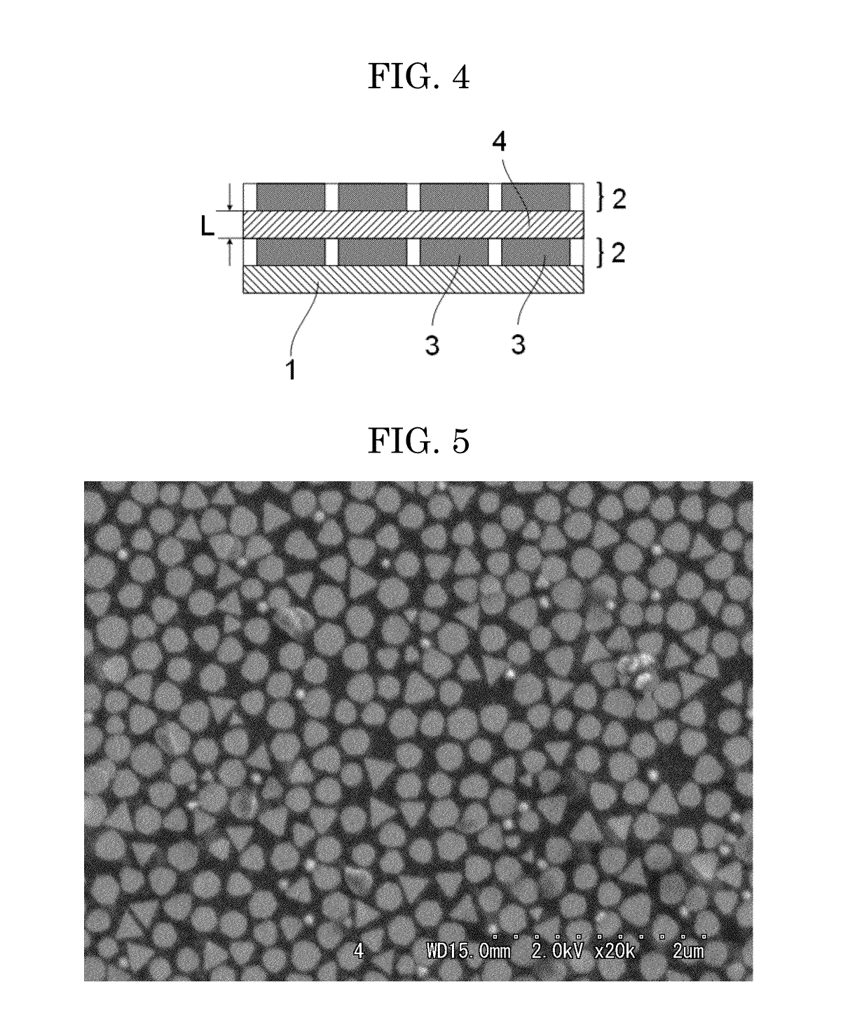

In the heat ray-shielding material of the present invention, the flat metal particles are arranged in the form of the metal particle-containing layer containing the flat metal particles, as illustrated in FIGS. 3A to 3C and 4.

As illustrated in FIG. 4, the heat ray-shielding material of the present invention has to contain at least two of the metal particle-containing layer. Since the heat ray-shielding material of the present invention contains a plurality of the metal particle-containing layers as illustrated in FIG. 4, advantageously, the heat ray-shielding material can have shielding property with respect to rays of an intended wavelength region.

When providing a plurality of the metal particle-containing layers, the distance between the metal particle-containing layers is preferably adjusted to 15 μm or greater, more preferably 30 μM or greater, particularly preferably 100 μm or greater, in order to suppress large influences due to coherent optical interference between the metal particle-containing layers and keep the metal particle-containing layers independent.

When the distance therebetween is smaller than 15 μm, the pitch width of interference peaks observed between the metal particle-containing layers is greater than 1/10 the half width of resonance peaks of the metal particle-containing layers containing the flat metal particles (i.e., about 300 nm to about 400 nm), potentially affecting the reflection spectrum.

Here, the distance L between the neighboring metal particle-containing layers refer to a distance between the metal particle-containing layers in FIG. 4. The distance between the metal particle-containing layers can be measured, for example, using an SEM image of a cross-sectional sample of the heat-ray shielding material.

### [Synthesis Method for Flat Metal Particles]

The synthesis method for the flat metal particles is not particularly limited and may be appropriately selected depending on the intended purpose. Examples thereof include liquid phase methods such as chemical reduction methods, photochemical reduction methods and electrochemical reduction methods. Among these liquid phase methods, preferred are chemical reduction methods and photochemical reduction methods from the viewpoint of controlling the shape and size. More preferred are methods where flat metal particles having a substantially hexagonal shape and/or a substantially disc shape can be synthesized. Furthermore, after hexagonal or triangular flat metal particles have been synthesized, they may be subjected to, for example, an etching treatment using chemical species that dissolve silver (e.g., nitric acid and sodium sulfite) or an aging treatment with heating so as to round the corners of the hexagonal or triangular flat metal particles, whereby substantially hexagonal and/or disc-shaped flat metal particles may be produced.

In an alternative synthesis method for the flat metal particles, seed crystals are fixed in advance on a surface of a transparent substrate (e.g., a film or a glass) and then are planarily grown to form metal particles (e.g., Ag).

In the heat ray-shielding material of the present invention, the flat metal particles may be subjected to a further treatment in order for the flat metal particles to have desired properties. The further treatment is not particularly limited and may be appropriately selected depending on the intended purpose. Examples thereof include formation of a high-refractive-index shell layer and addition of various additives such as a dispersing agent and an antioxidant.

### —High-Refractive-Index Material—

In order to further increase transparency with respect to visible light, the flat metal particles may be coated with a high-refractive-index material having high transparency with respect to visible light so as to form a high-refractive-index shell layer.

The refractive index of the high-refractive-index material is not particularly limited and may be appropriately selected depending on the intended purpose, but is preferably 1.6 or higher, more preferably 1.8 or higher, particularly preferably 2.0 or higher.

In a medium having a refractive index of about 1.5 such as glass or gelatin, when the refractive index thereof is lower than 1.6, the difference in refractive index between the high-refractive-index material and such a surrounding medium becomes almost zero. As a result, there may be a case where the AR effect or the haze-suppressing effect with respect to visible light for which the high-refractive-index shell layer is provided. Also, there may be a case where the surface density of one layer of flat metal particles cannot be increased since the thickness of the shell has to be larger with decreasing of the difference in refractive index therebetween. The above refractive index can be measured by, for example, spectroscopic ellipsometry (VASE, product of J. A. Woollam Co., Inc.).

The high-refractive-index material is not particularly limited and may be appropriately selected depending on the intended purpose. Examples thereof include Al₂O₃, TiOₓ, BaTiO₃, ZnO, SnO₂, ZrO₂ and NbOₓ, where x is an integer of 1 to 3. These may be used alone or in combination.

The method for coating the high-refractive-index material is not particularly limited and may be appropriately selected depending on the intended purpose. Examples thereof include a method in which a TiOₓ layer is formed on flat silver particles by hydrolyzing tetrabutoxytitanium as reported in Langmuir, 2000, Vol. 16, pp. 2731-2735.

When it is difficult to directly form the high-refractive-index material on the flat metal particles, a SiO₂ or polymer shell layer may appropriately be formed after the flat metal particles have been synthesized in the above-described manner. In addition, the above metal oxide layer may be formed on the high-refractive-index material. When TiOₓ is used as a material for the high-refractive-index metal oxide layer, there is concern that TiOₓ degrades a matrix in which flat metal particles are dispersed, since TiOₓ exhibits photocatalytic activity. Thus, depending on the intended purpose, a SiO₂ layer may appropriately be formed after formation of a TiOₓ on each flat metal particle.

### —Addition of Various Additives—

In the heat ray-shielding material of the present invention, an antioxidant (e.g., mercaptotetrazole or ascorbic acid) may be adsorbed onto the flat metal particles so as to prevent oxidation of the metal (e.g., silver) forming the flat metal particles. Also, an oxidation sacrificial layer (e.g., Ni) may be formed on the surfaces of the flat metal particles for preventing oxidation. Furthermore, the flat metal particles may be coated with a metal oxide film (e.g., SiO_{z} film) for shielding oxygen.

Also, a dispersing agent may be used for imparting dispersibility to the flat metal particles. Examples of the dispersing agent include high-molecular-weight dispersing agents and low-molecular-weight dispersing agents containing N, S and/or P such as quaternary ammonium salts and amines.

When n is an average refractive index of the surrounding region of the metal particles, the thickness of the metal particle-containing layer is preferably 2,500/(4n) nm or smaller from the viewpoint of increasing resonance reflectance and, from the viewpoint of reducing the haze with respect to visible light, the thickness of the metal particle-containing layer is more preferably 700/(4n) nm or smaller, particularly preferably 400/(4n) nm or smaller.

When the above thickness is larger than 2,500/(4n) nm, the haze may increase to reduce the amplification effect of the amplitudes of reflected waves due to their phases at the interfaces of the metal particle-containing layer on the upper side and on the lower side of the heat-ray shielding material, so that the reflectance at a resonance wavelength may greatly decrease.

The heat-ray shielding material of the present invention has a lamination structure where the metal particle-containing layers and the dielectric layer(s) are alternatingly laminated. The number of the metal particle-containing layers is 2 or more with the dielectric layer disposed therebetween.

When the number of the metal particle-containing layers is less than 2, optical interference cannot be obtained between the metal particle-containing layers, so that the effect of suppressing reflection of visible light cannot be obtained in some cases.

Regarding the reflectance of each metal particle-containing layer, preferably, the metal particle-containing layer closest to the surface of the heat-ray shielding material through which solar radiation enters has the highest reflectance and the metal particle-containing layer farthest from the surface of the heat-ray shielding material through which solar radiation enters has the lowest reflectance, with the reflectances of the intermediate metal particle-containing layers become sequentially lower from the metal particle-containing layer having the highest reflectance to the metal particle-containing layer having the lowest reflectance. The above reflectance reflects, to the greatest extent, the reflectance of the metal particle-containing layer (first layer) closest to the surface of the heat-ray shielding material through which solar radiation enters. As the distance from the surface becomes greater, the quantity of solar radiation that reaches the other layers is reduced as a result of absorption by the first layer, so that reflection characteristics of the other layers are not reflected very much. This configuration is advantageous in that it is possible to increase the reflectance of the combined metal particle-containing layers with respect to infrared rays.

In the metal particle-containing layer closest to the surface of the heat-ray shielding material through which solar radiation enters, the reflectance at a plasmon resonance peak wavelength (peak reflectance) is not particularly limited and may be appropriately selected depending on the intended purpose, but is preferably 30% or higher, more preferably 40% or higher, particularly preferably 50% or higher.

When the above reflectance is lower than 30%, shielding effects with respect to infrared rays cannot sufficiently be obtained in some cases.

The reflectance can be measured with, for example, a UV-Vis near-infrared spectrophotometer (product of JASCO Corporation, V-670).

The transmittance of the metal particle-containing layer is not particularly limited and may be appropriately selected depending on the intended purpose. The minimum value of the transmittance appears preferably within a wavelength range of 600 nm to 2,500 nm, more preferably 600 nm to 2,000 nm, still more preferably 700 nm to 2,000 nm, particularly preferably 780 nm to 1,800 nm.

When the wavelength at which the minimum value of the transmittance appears is shorter than 600 nm, visible light is shielded to darken or color the metal particle-containing layer. When it is longer than 2,500 nm, sunlight components are contained in a small quantity and sufficient shielding effects cannot be obtained in some cases.

### <Dielectric Layer>

The dielectric layer is not particularly limited so long as it is transparent with respect to light of the visible light region.

Examples of the material of the dielectric layer include inorganic compounds and organic compounds.

Examples of the inorganic compounds include silica, quartz, glass, silicon nitride, titania, alumina, aluminum nitride, zinc oxide, germanium oxide, zirconium oxide, niobium oxide, molybdenum oxide, indium oxide, tin oxide, tantalum oxide, tungsten oxide, lead oxide, diamond, boron nitride, carbon nitride, aluminum oxynitride and silicon oxynitride.

Examples of the organic compounds include polycarbonates, polyethylene terephthalates, polybutyrene terephthalates, polyethylene naphthalates, polymethyl methacrylates, polystyrenes, methyl styrene resins, acrylonitrile butadiene styrene (ABS) resins, acrylonitrile styrene (AS) resins, polyethylenes, polypropylenes, polymethylpentenes, polyoxetanes, Nylon 6, Nylon 66, polyvinyl chlorides, polyether sulfons, polysulfons, polyacrylates, cellulose triacetate, polyvinyl alcohols, polyacrylonitriles, cyclic polyolefins, acrylic resins, epoxy resins, cyclohexadiene polymers, amorphous polyester resins, transparent polyimides, transparent polyurethanes, transparent fluorine resins, thermoplastic elastomers and polylactic acids.

The refractive index of the dielectric layer is not particularly limited and may be appropriately selected depending on the intended purpose, but is preferably 1.0 to 10.0, more preferably 1.05 to 5.0, particularly preferably 1.1 to 4.0.

When the refractive index thereof is less than 1.0, it may be difficult to obtain a uniform dielectric layer as a thin film. When it is higher than 10.0, the average thickness required for the dielectric layer is about 10 nm, potentially making it difficult to form a uniform film. The refractive index can be measured by, for example, spectroscopic ellipsometry (VASE, product of J. A. Woollam Co., Inc.).

Preferably, the dielectric layer does not absorb light having a wavelength falling within the range of 400 nm to 700 nm. More preferably, it does not absorb light having a wavelength falling within the range of 380 nm to 2,500 nm.

When the dielectric layer absorbs light having a wavelength falling within the range of 400 nm to 700 nm, it absorbs visible light to adversely affect the color tone and visible light transmittance in some cases. When the dielectric layer absorbs light having a wavelength falling within the range of 380 nm to 2,500 nm, heat shielding is performed by absorption instead of reflection, potentially reducing heat shielding effects.

The optical thickness of the dielectric layer is determined with respect to wavelength λ1 at which the reflectance is the minimum. Specifically, there is preferably at least one dielectric layer having an optical thickness that satisfies the following expression (1).

When the dielectric layer has an optical thickness nd determined by the following expression (1), the reflectance of light at wavelength λ1 is advantageously suppressed by optical interference.

{(2m+1)×(λ1/4)}−{(λ1/4)×0.25}<nd<{(2m+1)×(λ1/4)}+{(λ1/4)×0.25} Expression (1)

In the above expression (1), m is an integer of 0 or greater, λ1 is a wavelength at which the reflectance is the minimum, n is a refractive index of the dielectric layer and d is a thickness (nm) of the dielectric layer. Here, the product of n and d; i.e., nd, is an optical thickness.

When m is 0, the nd in the above expression (1) is within {(2m+1)×(λ1/4)}±25% of (λ1/4), more preferably ±10% of (λ1/4), particularly preferably ±5% of (λ1/4).

So long as at least one of the dielectric layer has an optical thickness that satisfies the above expression (1), the optical thickness of the other dielectric layers is not particularly limited but m in the above expression (1) is preferably 0.

When m in the above expression (1) is 0, the reflectance can be reduced in wider wavelength range. It is advantageous in that it is possible to obtain a heat ray-shielding material which does not change much in color tone and reflectance with respect to oblique incident light.

The wavelength λ1 at which the reflectance is the minimum is not particularly limited and may be appropriately selected depending on the intended purpose, but is preferably 380 nm to 780 nm, more preferably 400 nm to 700 nm.

When the wavelength λ1 is shorter than 380 nm, it is in the ultraviolet region, whereas when the wavelength λ1 is longer than 780 nm, it is in the infrared region. Both of the regions are invisible regions for human eyes.

The optical thickness of the dielectric layer is not particularly limited and may be appropriately selected depending on the intended purpose, but is preferably 5 nm to 5,000 nm, more preferably 10 nm to 3,000 nm, particularly preferably 20 nm to 1,000 nm.

When the above optical thickness is smaller than 5 nm, it may be difficult to form a uniform dielectric layer. When it is larger than 5,000 nm, the optical interference effect between two layers becomes small.

The method for forming the dielectric layer is not particularly limited and may be appropriately selected depending on the intended purpose. Examples thereof include a method where a material having a refractive index of n is formed into a layer having a thickness of d. The method for forming the layer is not particularly limited and may be appropriately selected depending on the intended purpose. Preferably, the material is formed into a layer by, for example, a vapor deposition method capable of controlling the thickness accurately (including vacuum vapor deposition, ion assist vapor deposition, ion plating vapor deposition and ion beam sputtering vapor deposition) or a CVD method.

### <Other Members>

Examples of the other members include a substrate and a protective layer.

### <Substrate>

The substrate is not particularly limited, so long as it is optically transparent, and may be appropriately selected depending on the intended purpose. For example, the substrate is a substrate having a visible light transmittance of 70% or higher, preferably 80% or higher, or a substrate having a high transmittance with respect to lights of the near-infrared region.

The material for the substrate is not particularly limited and may be appropriately selected depending on the intended purpose. Examples thereof include glass materials (e.g., a white glass plate and a blue glass plate), polyethylene terephthalate (PET) and triacetylcellulose (TAC).

### —Protective Layer—

The heat ray-shielding material of the present invention preferably contains a protective layer for improving the adhesion to the substrate and mechanically protecting the resultant product.

The protective layer is not particularly limited and may be appropriately selected depending on the intended purpose. The protective layer contains, for example, a binder, a surfactant and a viscosity adjuster; and, if necessary, further contains other ingredients.

### —Binder—

The binder is not particularly limited and may be appropriately selected depending on the intended purpose. The binder preferably has higher transparency with respect to visible light and solar radiation. Examples thereof include acrylic resins, polyvinylbutyrals and polyvinylalcohols. Notably, when the binder absorbs heat rays, the reflection effects of the flat metal particles are disadvantageously weakened. Thus, when an intermediate layer is formed between the heat ray source and the flat metal particles, preferably, a material having no absorption of light having a wavelength of 780 nm to 1,500 nm is selected or the thickness of the protective layer is made small.

The thickness of the binder is not particularly limited and may be appropriately selected depending on the intended purpose, but is preferably 1 nm to 10,000 nm, more preferably 3 nm to 1,000 nm, particularly preferably 5 nm to 500 nm.

When the thickness thereof is smaller than 1 nm, the metal particle-containing layer cannot be protected. Whereas when it is larger than 10,000 nm, the selective reflection effect of the metal particles may be weakened due to interference as a result of, for example, reflection on the metal particles in the binder or reflection at the interface between the binder and the dielectric layer.

The visible light ray reflectance of the heat-ray shielding material of the present invention is not particularly limited and may be appropriately selected depending on the intended purpose. It is preferably 15% or lower, more preferably 10% or lower, particularly preferably 8% or lower, in a state where the binder is sandwiched between the glass substrate and the protective layer.

When the visible light ray reflectance is higher than 15%, glare of reflected light may be much more considerable than that of a glass plate. Since the glass substrate or the protective layer has a both surface reflectance of about 7.8%, the visible light ray reflectance thereof is preferably 7.2% or lower, more preferably 2.2% or lower, particularly preferably 0.2% or lower, as the visible light ray reflectance of the heat ray-shielding portion containing the dielectric layer and the metal particle-containing layers.

The visible light ray reflectance can be measured according to the method of JIS-R3106: 1998 “Testing method on transmittance, reflectance and emittance of flat glasses and evaluation of solar heat gain coefficient.”

The visible light ray transmittance of the heat-ray shielding material of the present invention is not particularly limited and may be appropriately selected depending on the intended purpose, but is preferably 60% or higher, more preferably 65% or higher, particularly preferably 70% or higher.

When the visible light ray transmittance is lower than 60%, there may be a case where the outside may be hard to see when the heat-ray shielding material is used as, for example, automotive glass or building glass.

The visible light ray transmittance can be measured according to the method of JIS-R3106: 1998 “Testing method on transmittance, reflectance and emittance of flat glasses and evaluation of solar heat gain coefficient.”

The solar heat gain coefficient of the heat-ray shielding material of the present invention is not particularly limited and may be appropriately selected depending on the intended purpose, but is preferably 70% or lower, more preferably 50% or lower, particularly preferably 40% or lower.

When the solar heat gain coefficient is higher than 70%, the effect of shielding heat is poor and heat shielding property is not sufficient in some cases.

The solar heat gain coefficient can be measured according to the method of JIS-R3106: 1998 “Testing method on transmittance, reflectance and emittance of flat glasses and evaluation of solar heat gain coefficient.”

The haze of the heat-ray shielding material of the present invention is not particularly limited and may be appropriately selected depending on the intended purpose, but is preferably 20% or lower, more preferably 10% or lower, particularly preferably 5% or lower.

When the haze is higher than 20%, there may be a case where when the heat-ray shielding material is used as, for example, automotive glass or building glass, the outside may be hard to see, which is not preferred in terms of safety.

The haze can be measured according to, for example, the method of JIS K7136 and JIS K7361-1.

### [Method for Producing the Heat-Ray Shielding Material]

The method for producing the heat ray-shielding material is not particularly limited and may be appropriately selected depending on the intended purpose. In one employable method, a substrate is coated with a dispersion liquid containing the metal particles using, for example, a dip coater, a die coater, a slit coater, a bar coater or a gravure coater. In another employable method, the flat metal particles are plane-oriented by, for example, an LB film method, a self-organizing method and spray coating.

Also, a method utilizing electrostatic interactions may be applied to plane orientation in order to increase adsorbability or plane orientability of the metal particles on the substrate surface. Specifically, when the surfaces of the metal particles are negatively charged (for example, when the metal particles are dispersed in a negatively chargeable medium such as citric acid), the substrate surface is positively charged (for example, the substrate surface is modified with, for example, an amino group) to electrostatically enhance plane orientability. Also, when the surfaces of the metal particles are hydrophilic, the substrate surface may be provided with a sea-island structure having hydrophilic and hydrophobic regions using, for example, a block copolymer or a micro contact stamp, to thereby control the plane orientability and the interparticle distance of the flat metal particles utilizing hydrophilic-hydrophobic interactions.

Notably, the coated metal particles are allowed to pass through pressure rollers (e.g., calender rollers or rami rollers) to promote their plane orientation.

After the metal particle-containing layer has been formed by the above-described method, the dielectric layer is formed (laminated) on the formed metal particle-containing layer.

Examples of the method for forming the dielectric layer include coating using, for example, a dip coater, a die coater, a slit coater, a bar coater or a gravure coater; an LB film method, a self-organizing method and spray coating.

After the dielectric layer has been formed, the metal particle-containing layer is formed again on the dielectric layer in the same manner as described above. If necessary, the above lamination process is repeated.

### [Usage Form of the Heat-Ray Shielding Material]

The usage form of the heat ray-shielding material of the present invention is not particularly limited and may be appropriately selected depending on the intended purpose so long as it is used for selectively reflecting or absorbing heat rays (near-infrared rays). Examples thereof include vehicles' glass or films, building glass or films and agricultural films. Among them, the heat ray-shielding material is preferably used as vehicles' glass or films and building glass or films in terms of energy saving.

Notably, in the present invention, heat rays (near-infrared rays) refer to near-infrared rays (780 nm to 2,500 nm) accounting for about 50% of sunlight.

The method for producing the glass is not particularly limited and may be appropriately selected depending on the intended purpose. In one employable method, the heat ray-shielding material produced in the above-described manner is provided with an adhesive layer, and the resultant laminate is attached onto vehicle's glass (e.g., automotive glass) or building glass or is inserted together with a PVB or EVA intermediate film used in laminated glass. Alternatively, only particle/binder layer may be transferred onto a PVB or EVA intermediate film; i.e., the substrate may be peeled off in use.

### EXAMPLES

The present invention will next be described by way of Examples, which should not be construed as limiting the present invention thereto.

### Example 1

### Production of Heat-Ray Shielding Material

### —Synthesis of Flat Metal Particles—

A 0.5 g/L aqueous polystyrenesulfonic acid solution (2 5 mL) was added to a 2.5 mM aqueous sodium citrate solution (50 mL), followed by heating to 35° C. Then, a 10 mM sodium borohydride solution (3 mL) was added to the resultant solution. Next, a 0.5 mM aqueous silver nitrate solution (50 mL) was added thereto at 20 mL/min under stirring. This solution was stirred for 30 min to prepare a seed particle solution.

Next, ion-exchanged water (127.6 mL) was added to a 2.5 mM aqueous sodium citrate solution (132.7 mL), followed by heating to 35° C. Subsequently, a 10 mM aqueous ascorbic acid solution (2 mL) was added to the resultant solution and then 42.4 mL of the above-prepared seed particle solution was added thereto. Furthermore, a 0.5 mM aqueous silver nitrate solution (79.6 mL) was added thereto at 10 mL/min under stirring. Next, the above-obtained solution was stirred for 30 min, and then a 0.35 M aqueous potassium hydroquinonesulfonate solution (71.1 mL) was added thereto. Furthermore, 200 g of a 7% aqueous gelatin solution was added thereto. Separately, 0.25 M aqueous sodium sulfite solution (107 mL) and a 0.47 M aqueous silver nitrate solution (107 mL) were mixed together to prepare a mixture containing white precipitates. The thus-prepared mixture was added to the solution to which the aqueous gelatin solution had been added. Immediately after the addition of the mixture containing white precipitates, a 0.08 M aqueous NaOH solution (72 mL) was added to the resultant mixture. Here, the aqueous NaOH solution was added thereto at an addition rate adjusted so that the pH of the mixture did not exceed 10. The thus-obtained mixture was stirred for 300 min to prepare a dispersion liquid of flat silver particles.

It was confirmed that this dispersion liquid of flat silver particles contained hexagonal flat particles of silver having an average circle-equivalent diameter of 170 nm (hereinafter referred to as “hexagonal flat silver particles”). Also, when the thicknesses of the hexagonal flat silver particles were measured with an atomic force microscope (AFM) (Nanocute II, product of Seiko Instruments Inc.), the average thickness thereof was found to be 10 nm, and it was found that the formed hexagonal flat silver particles had an aspect ratio of 17.0.

### —Formation of a Metal Particle-Containing Layer (First Layer)—

First, 1N NaOH (0.75 mL) was added to the above-prepared dispersion liquid of flat silver particles (16 mL). Then, ion-exchanged water (24 mL) was added to the resultant mixture, followed by centrifugating with a centrifuge (product of KOKUSAN Co., Ltd., H-200N, ANGLE ROTOR BN) at 5,000 rpm for 5 min, to thereby precipitate hexagonal flat silver particles. The supernatant after the centrifugation was removed and then water (6 mL) was added thereto to re-disperse the precipitated hexagonal flat silver particles. Thereafter, 1.6 mL of a 2% by mass aqueous methanol solution (water:methanol=1:1 (by mass)) was added to the resultant dispersion liquid to thereby prepare a coating liquid. The thus-prepared coating liquid was coated onto a PET film with a wire coating bar No. 14 (product of R.D.S Webster N.Y. Co.), followed by drying, to thereby obtain a film on which hexagonal flat silver particles were fixed.

A carbon thin film was formed by vapor deposition on the obtained PET film so as to have a thickness of 20 nm. When the resultant film was observed under a SEM (product of Hitachi Ltd., FE-SEM, S-4300, 2 kV, ×20,000), the hexagonal flat silver particles were fixed on the PET film without aggregation.

—Formation of a dielectric layer (first layer)—

A dielectric layer was formed on the metal particle-containing layer (first layer) by vapor-depositing SiO₂ through electron beam vapor deposition (using EBX-8C, product of ULVAC, Inc.). In this vapor deposition, the thickness of the SiO₂ layer was adjusted to 80 nm based on the value of a quartz crystal unit (product of ULVAC TECHNO Inc., gold 5 MHz_CR5G1).

### —Formation of a Metal Particle-Containing Layer (Second Layer)—

A dispersion liquid of flat silver particles was prepared in the same manner as in the above “Synthesis of flat metal particles.” Using the dispersion liquid of flat silver particles, hexagonal flat silver particles were fixed on the dielectric layer of SiO₂ in the same manner as in the above “Formation of a metal particle-containing layer (first layer)” to thereby form a metal particle-containing layer (second layer).

A carbon thin film was formed by vapor deposition on the formed metal particle-containing layer (second layer) so as to have a thickness of 20 nm. When the resultant film was observed under the SEM, the hexagonal flat silver particles were fixed on the dielectric layer without aggregation. Through the above procedure, a heat-ray shielding material of Example 1 was produced.

### (Evaluation)

Next, the obtained metal particles and the heat-ray shielding material were evaluated for properties in the following manner. The results are shown in Tables 1-1 to 3-2. Notably, in the present Examples, λ1 (i.e., a wavelength at which the reflectance is the minimum) was 500 nm (green).

### <Evaluation of Metal Particles>

### —Rate of Flat Particles, Average Circle-Equivalent Diameter and Coefficient of Variation—

Uniformity in shape of the flat silver particles was determined as follows. Specifically, 200 particles were randomly selected from the SEM image observed. Then, image processing was performed on their shapes, with A and B corresponding respectively to substantially hexagonal and/or disc-shaped particles and indefinite particles (e.g., drop-shaped particles). Subsequently, the rate by number of the particles corresponding to A (% by number) was calculated.

Similarly, 100 particles corresponding to A were measured for particle diameter with a digital caliper. The average value of the particle diameters was defined as an average circle-equivalent diameter. Moreover, the standard deviation of the circle-equivalent diameters was divided by the average circle-equivalent diameter to obtain coefficient of variation (%).

### —Thickness of the Dielectric Layer (the Distance Between the Two Layers)—

The heat-ray shielding material of Example 1 was cut by ion milling including applying argon ion beams, to thereby prepare a vertically cross-sectional sample of the heat-ray shielding material. The vertically cross-sectional sample was observed with a scanning electron microscope (SEM) to measure the thickness d of the dielectric layer.

### —Average Particle Thickness—

The dispersion liquid containing the flat metal particles was dropped on a glass substrate, followed by drying. Then, the thickness of each flat metal particle was measured with an atomic force microscope (AFM) (Nanocute II, product of Seiko Instruments Inc.). Notably, the measurement conditions of AFM were as follows: self-detection sensor, DFM mode, measurement range: 5 μm, scanning speed: 180 sec/frame and the number of data: 256×256.

### —Aspect Ratio—

The average circle-equivalent diameter was divided by the average particle thickness to obtain an aspect ratio of the obtained flat metal particles.

### —Area Ratio—

The obtained heat ray-shielding material was observed under a scanning electron microscope (SEM). The obtained SEM image was binarized to determine an area ratio of (B/A)×100, where A and B denote respectively an area of the substrate and the total value of areas of the flat metal particles when the heat ray-shielding material was viewed from above of the heat ray-shielding material.

### —Refractive Index of the Dielectric Layer—

SiO₂, which is the same material as the dielectric layer, was formed into a layer on a Si substrate and was measured for refractive index by spectroscopic ellipsometry at a wavelength of 500 nm.

—Optical Thickness of Dielectric Layer (nd)—

The thickness d of the dielectric layer measured in the above “Thickness of the dielectric layer (the distance between the two layers)” and the refractive index n measured in the above “Refractive index of the dielectric layer” were used to calculate an optical thickness (nd).

Also, it was confirmed whether or not the obtained optical thickness satisfies the above expression (1), where m was set to 0 or 60 and λ1 was set to 500 nm.

The thickness d of the dielectric layer measured in the above “Thickness of the dielectric layer (the distance between the two layers)” and the refractive index n measured in the above “Refractive index of the dielectric layer” were used to calculate nd/λ1 where λ1 is a wavelength of 500 nm.

### <Evaluation of the Heat-Ray Shielding Material>

### —Visible Light Transmission Spectrum and Heat Ray Reflection Spectrum—

The obtained heat ray-shielding material was measured for transmission spectrum and reflection spectrum according to JISR3106 which is evaluation standard for automotive glass.

The transmission and reflection spectra were evaluated with a UV-Vis near-infrared spectrophotometer (product of JASCO Corporation, V-670). The evaluation was performed using an absolute reflectance measurement unit (ARV-474, product of JASCO Corporation). Here, incident light was caused to pass through a 45° polarization plate so as to become substantially non-polarized light.

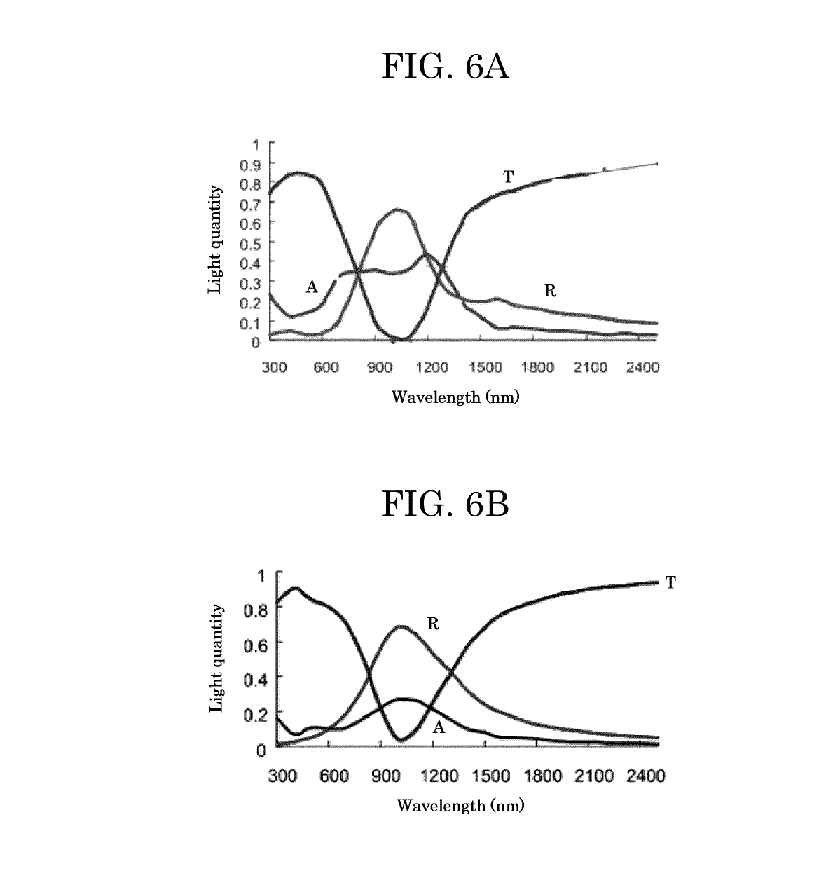

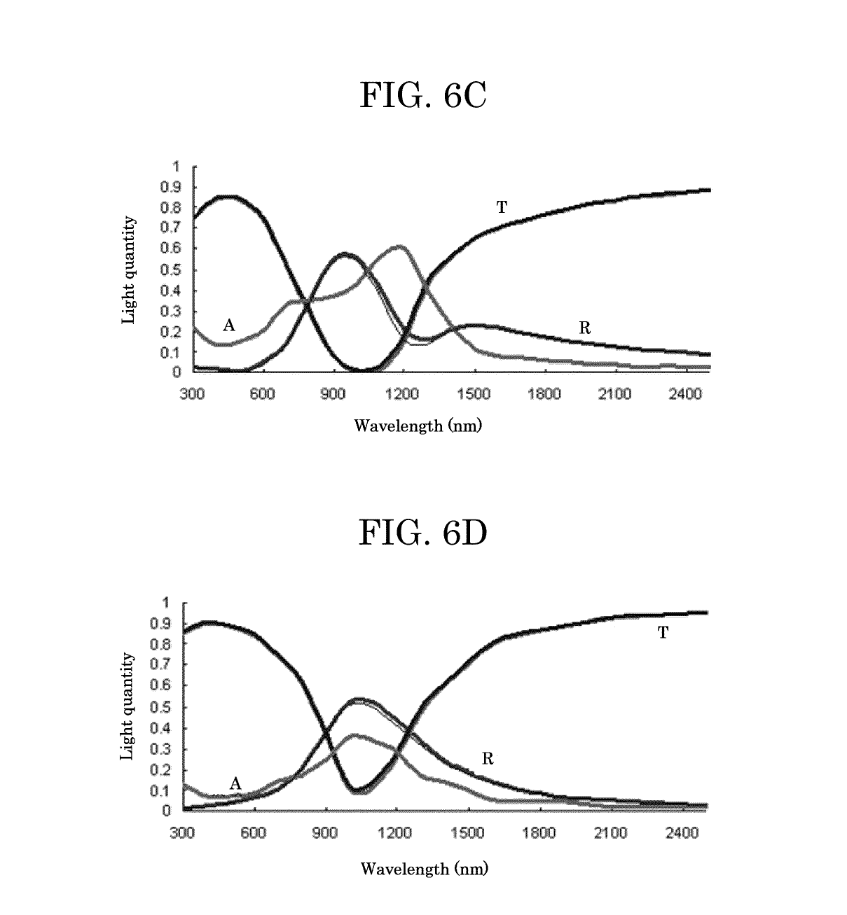

FIG. 6C shows spectra of the heat ray-shielding material of Example 1 where the reflection by the surface of the substrate was not included and only the metal particle-containing layer was measured. These spectra were used to calculate the peak reflectance and the wavelength at which the maximum reflection value was observed. —Solar Heat Gain Coefficient, Visible Light Ray Transmittance and Visible Light Ray Reflectance—

The solar heat gain coefficient, visible light ray transmittance and visible light ray reflectance were measured from 300 nm to 2,100 nm according to the method of JIS-R3106: 1998 “Testing method on transmittance, reflectance and emittance of flat glasses and evaluation of solar heat gain coefficient.” According to JIS-R3106, the measurements were used to calculate the solar heat gain coefficient, visible light ray transmittance and visible light ray reflectance. This measurement was performed in a state where the heat-ray shielding material was placed so that the metal particle-containing layer (first layer) was the closest to the side of incident light; i.e., the metal particle-containing layer (first layer), the dielectric layer (SiO₂ layer) and the metal particle-containing layer (second layer) were ordered from the side of incident light in a depth direction of the heat-ray shielding material.

Also, the maximum reflection value was obtained from the optical reflection spectrum obtained from the above-obtained measurements, to thereby determine the wavelength at which the maximum reflection value was observed. In addition, the reflectance at this wavelength was defined as the maximum reflectance (peak reflectance).

### —Surface Resistance—

The surface resistance (Ω/square) of the heat ray-shielding material obtained in the above-described manner was measured using a surface resistance measurement device (RORESTER, product of Mitsubishi Chemical Analytech Co. Ltd.).

### —Minimum Transmittance of the Metal Particle-Containing Layer—

When the transmittance spectrum is described, the minimum value of the transmittance appears in the downward convex. The transmittance of the metal particle-containing layer at a wavelength corresponding to the minimum value was defined as the minimum transmittance.

### —Peak Reflectance of the Metal Particle-Containing Layer—

For the heat-ray shielding material containing two or more layers of the metal particle-containing layer, a sample of only the metal particle-containing layer (first layer) was prepared in order to examine properties of the metal particle-containing layer (first layer) only. Specifically, the metal particle-containing layer (first layer) was measured as follows and also the metal particle-containing layer (second layer) was measured in the same manner.

A dispersion liquid of flat silver particles was prepared in the same manner as in the above “Synthesis of flat metal particles.” The dispersion liquid of flat silver particles was used to obtain a film of a metal particle-containing layer (first layer) on a surface of which hexagonal flat silver particles were fixed in the same manner as in the above “Formation of a metal particle-containing layer (first layer).”

This film was subjected to measurement using the same optical measurement method as in the above “Visible light transmission spectrum and heat ray reflection spectrum” and “Solar heat gain coefficient, visible light ray transmittance and visible light ray reflectance,” to thereby obtain the maximum reflectance which was defined as the peak reflectance of the metal particle-containing layer.

### Comparative Examples 1 and 2 and Example 6

Heat-ray shielding materials were produced in the same manner as in Example 1 except that the thickness of the dielectric layer of SiO₂ vapor-deposited was changed as shown in Table 1-1. The obtained heat-ray shielding materials and metal particles were evaluated for properties in the same manner as in Example 1. The results are shown in Tables 1-1 to 3-2.

### Comparative Example 3

A heat-ray shielding material was produced in the same manner as in Example 1 except that none of the dielectric layer and the metal particle-containing layer (second layer) was formed. The obtained heat-ray shielding material and metal particles were evaluated for properties in the same manner as in Example 1. The results are shown in Tables 1-1 to 3-2.

FIG. 6D shows the measured visible light transmission spectrum and heat ray reflection spectrum. FIG. 6D shows spectra of the heat ray-shielding material of Comparative Example 3 where the reflection by the surface of the substrate was not included and only the metal particle-containing layer was measured.

### Example 2

A heat-ray shielding material was produced in the same manner as in Example 1 except that the amount of water used for forming the metal particle-containing layers (first and second layers) was changed from 6 mL to 4 mL. The obtained heat-ray shielding material and metal particles were evaluated for properties in the same manner as in Example 1. The results are shown in Tables 1-1 to 3-2.

### Comparative Examples 4 and 5 and Example 7

Heat-ray shielding materials were produced in the same manner as in Example 2 except that the thickness of the dielectric layer of SiO₂ vapor-deposited was changed as shown in Table 1-1. The obtained heat-ray shielding materials and metal particles were evaluated for properties in the same manner as in Example 1. The results are shown in Tables 1-1 to 3-2.

### Comparative Example 6

A heat-ray shielding material was produced in the same manner as in to Example 3 except that the amount of water was changed from 6 mL to 4 mL. The obtained heat-ray shielding material and metal particles were evaluated for properties in the same manner as in Example 1. The results are shown in Tables 1-1 to 3-2.

FIG. 6B shows the measured visible light transmission spectrum and heat is ray reflection spectrum. FIG. 6B shows spectra of the heat ray-shielding material of Comparative Example 6 where the reflection by the surface of the substrate was not included and only the metal particle-containing layer was measured.

### Example 3

A heat-ray shielding material was produced in the same manner as in Example 1 except that the amount of the 2.5 mM aqueous sodium citrate solution used for synthesizing the flat metal particles of the metal particle-containing layers (first and second layers) was changed from 132.7 mL to 255.2 mL. The obtained heat-ray shielding material and metal particles were evaluated for properties in the same manner as in Example 1. The results are shown in Tables 1-1 to 3-2.

### Comparative Examples 7 and 8

Heat-ray shielding materials were produced in the same manner as in Example 3 except that the thickness of the SiO₂ vapor-deposited was changed as shown in Table 1-1. The obtained heat-ray shielding materials and metal particles were evaluated for properties in the same manner as in Example 1. The results are shown in Tables 1-1 to 3-2.

### Comparative Example 9

A heat-ray shielding material was produced in the same manner as in Comparative Example 3 except that the amount of the 2.5 mM aqueous sodium citrate solution used for synthesizing the flat metal particles of the metal particle-containing layers (first and second layers) was changed from 132.7 mL to 255.2 mL. The obtained heat-ray shielding material and metal particles were evaluated for properties in the same manner as in Example 1. The results are shown in Tables 1-1 to 3-2.

### Example 4

A heat-ray shielding material was produced in the same manner as in Example 1 except that the amount of water used for producing the metal particle-containing layer (first layer) was changed from 6 mL to 4 mL and that the amount of water used for producing the metal particle-containing layer (second layer) was changed from 6 mL to 11 mL. The obtained heat-ray shielding material and metal particles were evaluated for properties in the same manner as in Example 1. The results are shown in Tables 1-1 to 3-2.

FIG. 6A shows the measured visible light transmission spectrum and heat ray reflection spectrum. FIG. 6A shows spectra of the heat ray-shielding material of Example 4 where the reflection by the surface of the substrate was not included and only the metal particle-containing layer was measured.

### Comparative Example 10

A heat-ray shielding material was produced in the same manner as in Example 4 except that the thickness of the SiO₂ vapor-deposited was changed as shown in Table 1-1. The obtained heat-ray shielding material and metal particles were evaluated for properties in the same manner as in Example 1. The results are shown in Tables 1-1 to 3-2.

### Comparative Example 11

A heat-ray shielding material was produced in the same manner as in Comparative Example 3 except that the amount of water used for producing the metal particle-containing layer (first layer) was changed from 6 mL to 4 mL and that the amount of water used for producing the metal particle-containing layer (second layer) was changed from 6 mL to 11 mL. The obtained heat-ray shielding material and metal particles were evaluated for properties in the same manner as in Example 1. The results are shown in Tables 1-1 to 3-2.

### Example 5

A heat-ray shielding material was produced in the same manner as in Example 1 except that the amount of water used for producing the metal particle-containing layer (first layer) was changed from 6 mL to 11 mL and that the amount of water used for producing the metal particle-containing layer (second layer) was changed from 6 mL to 4 mL. The obtained heat-ray shielding material and metal particles were evaluated for properties in the same manner as in Example 1. The results are shown in Tables 1-1 to 3-2.

### Comparative Examples 12 and 13

Heat-ray shielding materials were produced in the same manner as in Example 5 except that the thickness of the SiO₂ vapor-deposited was changed as shown in Table 1-1. The obtained heat-ray shielding materials and metal particles were evaluated for properties in the same manner as in Example 1. The results are shown in Tables 1-1 to 3-2.

### Example 8

A heat-ray shielding material was produced in the same manner as in Example 1 except that 72 mL of the 0.08 M aqueous NaOH solution used for producing the metal particle-containing layers (first and second layers) was changed to 72 mL of a 0.17 M aqueous NaOH solution. The obtained heat-ray shielding materials and metal particles were evaluated for properties in the same manner as in Example 1. The results are shown in Tables 1-1 to 3-2.

### Comparative Examples 14 and 15

Heat-ray shielding materials were produced in the same manner as in Example 8 except that the thickness of the SiO₂ vapor-deposited was changed as shown in Table 1-2. The obtained heat-ray shielding materials and metal particles were evaluated for properties in the same manner as in Example 1. The results are shown in Tables 1-1 to 3-2.

### Example 9

A heat-ray shielding material was produced in the same manner as in Example 8 except that the amount of the ion-exchanged water used for producing the metal particle-containing layers (first and second layers) was changed from 127.6 mL to 87.1 mL. The obtained heat-ray shielding material and metal particles were evaluated for properties in the same manner as in Example 1. The results are shown in Tables 1-1 to 3-2.

### Comparative Examples 16 and 17

Heat-ray shielding materials were produced in the same manner as in Example 9 except that the thickness of the SiO₂ vapor-deposited was changed as shown in Table 1-2. The obtained heat-ray shielding materials and metal particles were evaluated for properties in the same manner as in Example 1. The results are shown in Tables 1-1 to 3-2.

### Example 10

A heat-ray shielding material was produced in the same manner as in Example 1 except that the amount of the 2.5 mM aqueous sodium citrate solution used for synthesizing the flat metal particles of the metal particle-containing layer (second layer) was changed from 132.7 mL to 255.2 mL. The obtained heat-ray shielding material and metal particles were evaluated for properties in the same manner as in Example 1. The results are shown in Tables 1-1 to 3-2.

### Comparative Examples 18 and 19

Heat-ray shielding materials were produced in the same manner as in Example 10 except that the thickness of the SiO₂ vapor-deposited was changed as shown in Table 1-2. The obtained heat-ray shielding materials and metal particles were evaluated for properties in the same manner as in Example 1. The results are shown in Tables 1-1 to 3-2.

### Example 11

A heat-ray shielding material was produced in the same manner as in Example 1 except that the amount of the 2.5 mM aqueous sodium citrate solution used for synthesizing the flat metal particles of the metal particle-containing layer (first layer) was changed from 132.7 mL to 255.2 mL. The obtained heat-ray shielding material and metal particles were evaluated for properties in the same manner as in Example 1. The results are shown in Tables 1-1 to 3-2.

### Comparative Examples 20 and 21

Heat-ray shielding materials were produced in the same manner as in Example 11 except that the thickness of the SiO₂ vapor-deposited was changed as shown in Table 1-2. The obtained heat-ray shielding materials and metal particles were evaluated for properties in the same manner as in Example 1. The results are shown in Tables 1-1 to 3-2.

### Example 12

A heat-ray shielding material was produced in the same manner as in Example 1 except that SiO₂ was changed to ZrO₂. The obtained heat-ray shielding materials and metal particles were evaluated for properties in the same manner as in Example 1. The results are shown in Tables 1-1 to 3-2.

### Comparative Examples 22 to 25

Heat-ray shielding materials were produced in the same manner as in Example 12 except that the thickness of the ZrO₂ vapor-deposited was changed as shown in Table 1-2. The obtained heat-ray shielding materials and metal particles were evaluated for properties in the same manner as in Example 1. The results are shown in Tables 1-1 to 3-2.

### Example 13

A heat-ray shielding material was produced in the same manner as in Example 1 except that dilute nitric acid was added to the dispersion liquid of flat silver particles for the metal particle-containing layers (first and second layers) and the resultant mixture was subjected to an aging treatment of heating at 80° C. for 1 hour. As a result of observing the particles having been subjected to the aging treatment under a TEM, it was confirmed that the corners of the hexagons were rounded to change into substantially disc shapes. The obtained heat-ray shielding is material and metal particles were evaluated for properties in the same manner as in Example 1. The results are shown in Tables 1-1 to 3-2.

### Comparative Examples 26 to 28

Heat-ray shielding materials were produced in the same manner as in Example 13 except that the thickness of the dielectric layer of SiO₂ vapor-deposited was changed as shown in Table 1-2. The obtained heat-ray shielding materials and metal particles were evaluated for properties in the same manner as in Example 1. The results are shown in Tables 1-1 to 3-2.

### Example 14

A heat-ray shielding material was produced in the same manner as in Example 1 except that the hexagonal flat silver particles in the metal particle-containing layers (first and second layers) were coated in the below-described manner with a high-refractive-index material TiO₂ to form TiO₂ shells. The obtained heat-ray shielding materials and metal particles were evaluated for properties in the same manner as in Example 1. The results are shown in Tables 1-1 to 3-2. Notably, when the refractive index of TiO₂ was measured by spectroscopic ellipsometry (VASE, product of J. A. Woollam Co., Inc.), it was found to be 2.2.

### —Formation of TiO₂ Shells—

TiO₂ shells were formed referring to literature (Langmuir, 2000, Vol. 16, pp. 2731-2735). Specifically, 2 mL of tetraethoxytitanium, 2.5 mL of acetylacetone and 0.1 mL of dimethylamine were added to the dispersion liquid of hexagonal flat silver particles, followed by stirring for 5 hours, to thereby obtain hexagonal flat silver particles coated with TiO₂ shells. When the cross-sections of the hexagonal flat silver particles were observed under a SEM, the TiO₂ shells were found to have a thickness of 30 nm.

### Comparative Examples 29 and 30

Heat-ray shielding materials were produced in the same manner as in Example 14 except that the thickness of the dielectric layer of SiO₂ vapor-deposited was changed as shown in Table 1-2. The obtained heat-ray shielding materials and metal particles were evaluated for properties in the same manner as in Example 1. The results are shown in Tables 1-1 to 3-2.

TABLE 1-1

| | Metal particle-containing layer | | | | Metal particle-containing layer | | | | |
|---|---|---|---|---|---|---|---|---|---|
| | (first layer) | | | | (second layer) | | | | |
| | Av. | | | | Avg. | | | | |
| | circle-eq. | Avg. | | | circle-eq. | Avg. | | | Thickness |
| | diameter | thickness | Amount | | diameter | thickness | Amount | | d of |
| | of metal | of metal | of water | Area | of metal | of metal | of water | Area | dielectric |
| | particles | particles | used | ratio | particles | particles | used | ratio | layer |
| | (nm) | (nm) | (mL) | (%) | (nm) | (nm) | (mL) | (%) | (nm) |
| Ex. 1 | 170 | 10 | 6 | 41 | 170 | 10 | 6 | 41 | 80 |
| Comp. | 170 | 10 | 6 | 41 | 170 | 10 | 6 | 41 | 40 |
| Ex. 1 | | | | | | | | | |
| Comp. | 170 | 10 | 6 | 41 | 170 | 10 | 6 | 41 | 160 |
| Ex. 2 | | | | | | | | | |
| Comp. | 170 | 10 | 6 | 41 | — | — | — | — | — |
| Ex. 3 | | | | | | | | | |
| Ex. 2 | 170 | 10 | 4 | 49 | 170 | 10 | 4 | 49 | 80 |
| Comp. | 170 | 10 | 4 | 49 | 170 | 10 | 4 | 49 | 40 |
| Ex. 4 | | | | | | | | | |
| Comp. | 170 | 10 | 4 | 49 | 170 | 10 | 4 | 49 | 160 |
| Ex. 5 | | | | | | | | | |
| Comp. | 170 | 10 | 4 | 49 | — | — | — | — | — |
| Ex. 6 | | | | | | | | | |
| Ex. 3 | 115 | 10 | 6 | 41 | 115 | 10 | 6 | 41 | 80 |
| Comp. | 115 | 10 | 6 | 41 | 115 | 10 | 6 | 41 | 40 |
| Ex. 7 | | | | | | | | | |
| Comp. | 115 | 10 | 6 | 41 | 115 | 10 | 6 | 41 | 160 |
| Ex. 8 | | | | | | | | | |
| Comp. | 115 | 10 | 6 | 41 | — | — | — | — | — |
| Ex. 9 | | | | | | | | | |
| Ex. 4 | 170 | 10 | 4 | 49 | 170 | 10 | 11 | 29 | 80 |
| Comp. | 170 | 10 | 4 | 49 | 170 | 10 | 11 | 29 | 40 |
| Ex. 10 | | | | | | | | | |
| Comp. | 170 | 10 | 4 | 49 | 170 | 10 | 11 | 29 | 160 |
| Ex. 11 | | | | | | | | | |
| Ex. 5 | 170 | 10 | 11 | 29 | 170 | 10 | 4 | 49 | 80 |
| Comp. | 170 | 10 | 11 | 29 | 170 | 10 | 4 | 49 | 40 |
| Ex. 12 | | | | | | | | | |
| Comp. | 170 | 10 | 11 | 29 | 170 | 10 | 4 | 49 | 160 |
| Ex. 13 | | | | | | | | | |
| Ex. 7 | 170 | 10 | 4 | 49 | 170 | 10 | 4 | 49 | 10,080 |
| Ex. 6 | 170 | 10 | 6 | 41 | 170 | 10 | 6 | 41 | 10,080 |

TABLE 1-2

| | Metal particle-containing layer | | | | Metal particle-containing layer | | | | |
|---|---|---|---|---|---|---|---|---|---|
| | (first layer) | | | | (second layer) | | | | |
| | Av. | | | | Avg. | | | | |
| | circle-eq. | Avg. | | | circle-eq. | Avg. | | | Thickness |
| | diameter | thickness | Amount | | diameter | thickness | Amount | | d of |
| | of metal | of metal | of water | Area | of metal | of metal | of water | Area | dielectric |
| | particles | particles | used | ratio | particles | particles | used | ratio | layer |
| | (nm) | (nm) | (mL) | (%) | (nm) | (nm) | (mL) | (%) | (nm) |
| Ex. 8 | 145 | 13 | 6 | 41 | 145 | 13 | 6 | 41 | 80 |
| Comp. | 145 | 13 | 6 | 41 | 145 | 13 | 6 | 41 | 40 |
| Ex. 14 | | | | | | | | | |
| Comp. | 145 | 13 | 6 | 41 | 145 | 13 | 6 | 41 | 160 |
| Ex. 15 | | | | | | | | | |
| Ex. 9 | 210 | 18 | 6 | 41 | 210 | 18 | 6 | 41 | 80 |
| Comp. | 210 | 18 | 6 | 41 | 210 | 18 | 6 | 41 | 40 |
| Ex. 16 | | | | | | | | | |
| Comp. | 210 | 18 | 6 | 41 | 210 | 18 | 6 | 41 | 160 |
| Ex. 17 | | | | | | | | | |
| Ex. 10 | 170 | 10 | 6 | 41 | 115 | 10 | 6 | 41 | 80 |
| Comp. | 170 | 10 | 6 | 41 | 115 | 10 | 6 | 41 | 40 |
| Ex. 18 | | | | | | | | | |
| Comp. | 170 | 10 | 6 | 41 | 115 | 10 | 6 | 41 | 160 |
| Ex. 19 | | | | | | | | | |
| Ex. 11 | 115 | 10 | 6 | 41 | 170 | 10 | 6 | 41 | 80 |
| Comp. | 115 | 10 | 6 | 41 | 170 | 10 | 6 | 41 | 40 |
| Ex. 20 | | | | | | | | | |
| Comp. | 115 | 10 | 6 | 41 | 170 | 10 | 6 | 41 | 160 |
| Ex. 21 | | | | | | | | | |
| Ex. 12 | 170 | 10 | 6 | 41 | 170 | 10 | 6 | 41 | 60 |
| Comp. | 170 | 10 | 6 | 41 | 170 | 10 | 6 | 41 | 80 |
| Ex. 22 | | | | | | | | | |
| Comp. | 170 | 10 | 6 | 41 | 170 | 10 | 6 | 41 | 40 |
| Ex. 23 | | | | | | | | | |
| Comp. | 170 | 10 | 6 | 41 | 170 | 10 | 6 | 41 | 120 |
| Ex. 24 | | | | | | | | | |
| Comp. | 170 | 10 | 6 | 41 | 170 | 10 | 6 | 41 | 160 |
| Ex. 25 | | | | | | | | | |
| Ex. 13 | 170 | 10 | 6 | 41 | 170 | 10 | 6 | 41 | 80 |
| Comp. | 170 | 10 | 6 | 41 | 170 | 10 | 6 | 41 | 40 |
| Ex. 26 | | | | | | | | | |
| Comp. | 170 | 10 | 6 | 41 | 170 | 10 | 6 | 41 | 160 |
| Ex. 27 | | | | | | | | | |
| Comp. | 170 | 10 | 6 | 41 | — | — | — | — | — |
| Ex. 28 | | | | | | | | | |
| Ex. 14 | 170 | 10 | 6 | 41 | 170 | 10 | 6 | 41 | 80 |
| Comp. | 170 | 10 | 6 | 41 | 170 | 10 | 6 | 41 | 160 |
| Ex. 29 | | | | | | | | | |
| Comp. | 170 | 10 | 6 | 41 | — | — | — | — | — |
| Ex. 30 | | | | | | | | | |

TABLE 2-1-1

| | Metal particle-containing layer (first layer) | | | | | |
|---|---|---|---|---|---|---|
| | | | Avg. | | | Coefficient |
| | | Rate | circle- | | | of |
| | | of flat | eq. | Avg. | | variation |
| | | particles | di- | thick- | | of particle |
| | | (% by | ameter | ness | Aspect | size |
| | Shape | number) | (nm) | (nm) | ratio | distribution |
| Ex. 1 | Substantially | 91 | 170 | 10 | 17.0 | 8% |
| | hexagonal | | | | | |
| Comp. | Substantially | 91 | 170 | 10 | 17.0 | 8% |
| Ex. 1 | hexagonal | | | | | |
| Comp. | Substantially | 91 | 170 | 10 | 17.0 | 8% |
| Ex. 2 | hexagonal | | | | | |
| Comp. | Substantially | 91 | 170 | 10 | 17.0 | 8% |
| Ex. 3 | hexagonal | | | | | |
| Ex. 2 | Substantially | 91 | 170 | 10 | 17.0 | 8% |
| | hexagonal | | | | | |
| Comp. | Substantially | 91 | 170 | 10 | 17.0 | 8% |
| Ex. 4 | hexagonal | | | | | |
| Comp. | Substantially | 91 | 170 | 10 | 17.0 | 8% |
| Ex. 5 | hexagonal | | | | | |
| Comp. | Substantially | 91 | 170 | 10 | 17.0 | 8% |
| Ex. 6 | hexagonal | | | | | |
| Ex. 3 | Substantially | 89 | 115 | 10 | 11.5 | 9% |
| | hexagonal | | | | | |
| Comp. | Substantially | 89 | 115 | 10 | 11.5 | 9% |
| Ex. 7 | hexagonal | | | | | |
| Comp. | Substantially | 89 | 115 | 10 | 11.5 | 9% |
| Ex. 8 | hexagonal | | | | | |
| Comp. | Substantially | 89 | 115 | 10 | 11.5 | 9% |
| Ex. 9 | hexagonal | | | | | |
| Ex. 4 | Substantially | 91 | 170 | 10 | 17.0 | 8% |
| | hexagonal | | | | | |
| Comp. | Substantially | 91 | 170 | 10 | 17.0 | 8% |
| Ex. 10 | hexagonal | | | | | |
| Comp. | Substantially | 91 | 170 | 10 | 17.0 | 8% |
| Ex. 11 | hexagonal | | | | | |
| Ex. 5 | Substantially | 91 | 170 | 10 | 17.0 | 8% |
| | hexagonal | | | | | |
| Comp. | Substantially | 91 | 170 | 10 | 17.0 | 8% |
| Ex. 12 | hexagonal | | | | | |
| Comp. | Substantially | 91 | 170 | 10 | 17.0 | 8% |
| Ex. 13 | hexagonal | | | | | |
| Ex. 8 | Substantially | 88 | 145 | 13 | 11.2 | 10% |
| | hexagonal | | | | | |
| Comp. | Substantially | 88 | 145 | 13 | 11.2 | 10% |
| Ex. 14 | hexagonal | | | | | |
| Comp. | Substantially | 88 | 145 | 13 | 11.2 | 10% |
| Ex. 15 | hexagonal | | | | | |
| Ex. 9 | Substantially | 90 | 210 | 18 | 11.7 | 9% |
| | hexagonal | | | | | |
| Comp. | Substantially | 90 | 210 | 18 | 11.7 | 9% |
| Ex. 16 | hexagonal | | | | | |
| Comp. | Substantially | 90 | 210 | 18 | 11.7 | 9% |
| Ex. 17 | hexagonal | | | | | |

TABLE 2-1-2

| | Metal particle-containing layer (first layer) | | | | | |
|---|---|---|---|---|---|---|
| | | | Avg. | | | Coefficient |
| | | Rate | circle- | | | of |
| | | of flat | eq. | Avg. | | variation |
| | | particles | di- | thick- | | of particle |
| | | (% by | ameter | ness | Aspect | size |
| | Shape | number) | (nm) | (nm) | ratio | distribution |
| Ex. 10 | Substantially | 91 | 170 | 10 | 17.0 | 8% |
| | hexagonal | | | | | |
| Comp. | Substantially | 91 | 170 | 10 | 17.0 | 8% |
| Ex. 18 | hexagonal | | | | | |
| Comp. | Substantially | 91 | 170 | 10 | 17.0 | 8% |
| Ex. 19 | hexagonal | | | | | |
| Ex. 11 | Substantially | 89 | 115 | 10 | 11.5 | 9% |
| | hexagonal | | | | | |
| Comp. | Substantially | 89 | 115 | 10 | 11.5 | 9% |
| Ex. 20 | hexagonal | | | | | |
| Comp. | Substantially | 89 | 115 | 10 | 11.5 | 9% |
| Ex. 21 | hexagonal | | | | | |
| Ex. 12 | Substantially | 91 | 170 | 10 | 17.0 | 8% |
| | hexagonal | | | | | |
| Comp. | Substantially | 91 | 170 | 10 | 17.0 | 8% |
| Ex. 22 | hexagonal | | | | | |
| Comp. | Substantially | 91 | 170 | 10 | 17.0 | 8% |
| Ex. 23 | hexagonal | | | | | |
| Comp. | Substantially | 91 | 170 | 10 | 17.0 | 8% |
| Ex. 24 | hexagonal | | | | | |
| Comp. | Substantially | 91 | 170 | 10 | 17.0 | 8% |
| Ex. 25 | hexagonal | | | | | |
| Ex. 13 | Substantially | 91 | 170 | 10 | 17.0 | 8% |
| | disc-shaped | | | | | |
| Comp. | Substantially | 91 | 170 | 10 | 17.0 | 8% |
| Ex. 26 | disc-shaped | | | | | |
| Comp. | Substantially | 91 | 170 | 10 | 17.0 | 8% |
| Ex. 27 | disc-shaped | | | | | |
| Comp. | Substantially | 91 | 170 | 10 | 17.0 | 8% |
| Ex. 28 | disc-shaped | | | | | |
| Ex. 14 | Substantially | 91 | 170 | 10 | 17.0 | 8% |
| | disc-shaped | | | | | |
| Comp. | Substantially | 91 | 170 | 10 | 17.0 | 8% |
| Ex. 29 | disc-shaped | | | | | |
| Comp. | Substantially | 91 | 170 | 10 | 17.0 | 8% |
| Ex. 30 | disc-shaped | | | | | |
| Ex. 7 | Substantially | 91 | 170 | 10 | 17.0 | 8% |
| | hexagonal | | | | | |
| Ex. 6 | Substantially | 91 | 170 | 10 | 17.0 | 8% |
| | hexagonal | | | | | |

TABLE 2-2-1

| | Metal particle-containing layer (second layer) | | | | | |
|---|---|---|---|---|---|---|
| | | | Avg. | | | Coefficient |
| | | Rate | circle- | | | of |
| | | of flat | eq. | Avg. | | variation |
| | | particles | di- | thick- | | of particle |
| | | (% by | ameter | ness | Aspect | size |
| | Shape | number) | (nm) | (nm) | ratio | distribution |
| Ex. 1 | Substantially | 91 | 170 | 10 | 17.0 | 8% |
| | hexagonal | | | | | |
| Comp. | Substantially | 91 | 170 | 10 | 17.0 | 8% |
| Ex. 1 | hexagonal | | | | | |
| Comp. | Substantially | 91 | 170 | 10 | 17.0 | 8% |
| Ex. 2 | hexagonal | | | | | |
| Comp. | — | — | — | — | — | — |
| Ex. 3 | | | | | | |
| Ex. 2 | Substantially | 91 | 170 | 10 | 17.0 | 8% |
| | hexagonal | | | | | |
| Comp. | Substantially | 91 | 170 | 10 | 17.0 | 8% |
| Ex. 4 | hexagonal | | | | | |
| Comp. | Substantially | 91 | 170 | 10 | 17.0 | 8% |
| Ex. 5 | hexagonal | | | | | |
| Comp. | — | — | — | — | — | — |
| Ex. 6 | | | | | | |
| Ex. 3 | Substantially | 89 | 115 | 10 | 11.5 | 9% |
| | hexagonal | | | | | |
| Comp. | Substantially | 89 | 115 | 10 | 11.5 | 9% |
| Ex. 7 | hexagonal | | | | | |
| Comp. | Substantially | 89 | 115 | 10 | 11.5 | 9% |
| Ex. 8 | hexagonal | | | | | |
| Comp. | — | — | — | — | — | — |
| Ex. 9 | | | | | | |
| Ex. 4 | Substantially | 91 | 170 | 10 | 17.0 | 8% |
| | hexagonal | | | | | |
| Comp. | Substantially | 91 | 170 | 10 | 17.0 | 8% |
| Ex. 10 | hexagonal | | | | | |
| Comp. | Substantially | 91 | 170 | 10 | 17.0 | 8% |
| Ex. 11 | hexagonal | | | | | |
| Ex. 5 | Substantially | 91 | 170 | 10 | 17.0 | 8% |
| | hexagonal | | | | | |
| Comp. | Substantially | 91 | 170 | 10 | 17.0 | 8% |
| Ex. 12 | hexagonal | | | | | |
| Comp. | Substantially | 91 | 170 | 10 | 17.0 | 8% |
| Ex. 13 | hexagonal | | | | | |
| Ex. 8 | Substantially | 88 | 145 | 13 | 11.2 | 10% |
| | hexagonal | | | | | |
| Comp. | Substantially | 88 | 145 | 13 | 11.2 | 10% |
| Ex. 14 | hexagonal | | | | | |
| Comp. | Substantially | 88 | 145 | 13 | 11.2 | 10% |
| Ex. 15 | hexagonal | | | | | |
| Ex. 9 | Substantially | 90 | 210 | 18 | 11.7 | 9% |
| | hexagonal | | | | | |
| Comp. | Substantially | 90 | 210 | 18 | 11.7 | 9% |
| Ex. 16 | hexagonal | | | | | |
| Comp. | Substantially | 90 | 210 | 18 | 11.7 | 9% |
| Ex. 17 | hexagonal | | | | | |

TABLE 2-2-2

| | Metal particle-containing layer (second layer) | | | | | |
|---|---|---|---|---|---|---|
| | | | Avg. | | | Coefficient |
| | | Rate | circle- | | | of |
| | | of flat | eq. | Avg. | | variation |
| | | particles | di- | thick- | | of particle |
| | | (% by | ameter | ness | Aspect | size |
| | Shape | number) | (nm) | (nm) | ratio | distribution |
| Ex. 10 | Substantially | 89 | 115 | 10 | 11.5 | 9% |
| | hexagonal | | | | | |
| Comp. | Substantially | 89 | 115 | 10 | 11.5 | 9% |
| Ex. 18 | hexagonal | | | | | |
| Comp. | Substantially | 89 | 115 | 10 | 11.5 | 9% |
| Ex. 19 | hexagonal | | | | | |
| Ex. 11 | Substantially | 91 | 170 | 10 | 17.0 | 8% |
| | hexagonal | | | | | |
| Comp. | Substantially | 91 | 170 | 10 | 17.0 | 8% |
| Ex. 20 | hexagonal | | | | | |
| Comp. | Substantially | 91 | 170 | 10 | 17.0 | 8% |
| Ex. 21 | hexagonal | | | | | |
| Ex. 12 | Substantially | 91 | 170 | 10 | 17.0 | 8% |
| | hexagonal | | | | | |
| Comp. | Substantially | 91 | 170 | 10 | 17.0 | 8% |
| Ex. 22 | hexagonal | | | | | |
| Comp. | Substantially | 91 | 170 | 10 | 17.0 | 8% |
| Ex. 23 | hexagonal | | | | | |
| Comp. | Substantially | 91 | 170 | 10 | 17.0 | 8% |
| Ex. 24 | hexagonal | | | | | |
| Comp. | Substantially | 91 | 170 | 10 | 17.0 | 8% |
| Ex. 25 | hexagonal | | | | | |
| Ex. 13 | Substantially | 91 | 170 | 10 | 17.0 | 8% |
| | disc-shaped | | | | | |
| Comp. | Substantially | 91 | 170 | 10 | 17.0 | 8% |
| Ex. 26 | disc-shaped | | | | | |
| Comp. | Substantially | 91 | 170 | 10 | 17.0 | 8% |
| Ex. 27 | disc-shaped | | | | | |
| Comp. | Substantially | 91 | 170 | 10 | 17.0 | 8% |
| Ex. 28 | disc-shaped | | | | | |
| Ex. 14 | Substantially | 91 | 170 | 10 | 17.0 | 8% |
| | disc-shaped | | | | | |
| Comp. | Substantially | 91 | 170 | 10 | 17.0 | 8% |
| Ex. 29 | disc-shaped | | | | | |
| Comp. | Substantially | 91 | 170 | 10 | 17.0 | 8% |
| Ex. 30 | disc-shaped | | | | | |
| Ex. 7 | Substantially | 91 | 170 | 10 | 17.0 | 8% |
| | hexagonal | | | | | |
| Ex. 6 | Substantially | 91 | 170 | 10 | 17.0 | 8% |
| | hexagonal | | | | | |

TABLE 3-1

| | | | |
|---|---|---|---|
| Max. | 1^{st} | 2^{nd} | Visible |

| | | | | | | |
|---|---|---|---|---|---|---|
| Dielectric layer | re- | layer | layer | Visible | Solar | light |

| | | | | | Optical | | Peak | flec- | Peak | Peak | light | heat | ray | | Min. |
|---|---|---|---|---|---|---|---|---|---|---|---|---|---|---|---|
| | Re- | | | | thick- | | re- | tion | re- | re- | ray | gain | trans- | Surface | trans- |
| | frac- | | | | ness | | flec- | wave- | flec- | flec- | reflec- | coeffi- | mit- | resis- | mit- |
| | tive | | | | nd | | tance | length | tance | tance | tance | cient | tance | tance | tance |
| | index | nd/λ1 | m | A | (nm) | B | (%) | (nm) | (%) | (%) | (%) | (%) | (%) | (Ω/sq.) | (%) |
| Ex. 1 | 1.5 | 0.24 | 0 | 93.75 | 120 | 156.25 | 60 | 1,050 | 60 | 60 | 8 | 55 | 74 | 9.9 × 10¹² | 5 |
| Comp. | 1.5 | 0.12 | 0 | 93.75 | 60 | 156.25 | 59 | 1,050 | 60 | 60 | 15 | 49 | 64 | 9.9 × 10¹² | 6 |
| Ex. 1 | | | | | | | | | | | | | | | |
| Comp. | 1.5 | 0.48 | 0 | 93.75 | 240 | 156.25 | 56 | 1,050 | 60 | 60 | 19 | 58 | 72 | 9.9 × 10¹² | 7 |
| Ex. 2 | | | | | | | | | | | | | | | |
| Comp. | 1.5 | — | 0 | 93.75 | — | 156.25 | 60 | 1,050 | 60 | — | 11 | 63 | 79 | 9.9 × 10¹² | 8 |
| Ex. 3 | | | | | | | | | | | | | | | |
| Ex. 6 | 1.5 | 30.24 | 60 | 15093.75 | 15120 | 15156.25 | 66 | 1,050 | 60 | 60 | 14 | 53 | 69 | 9.9 × 10¹² | 4 |
| Ex. 2 | 1.5 | 0.24 | 0 | 93.75 | 120 | 156.25 | 75 | 1,050 | 75 | 75 | 8 | 49 | 66 | 9.9 × 10¹² | 4 |
| Comp. | 1.5 | 0.12 | 0 | 93.75 | 60 | 156.25 | 78 | 1,050 | 75 | 75 | 19 | 44 | 55 | 9.9 × 10¹² | 3 |
| Ex. 4 | | | | | | | | | | | | | | | |
| Comp. | 1.5 | 0.48 | 0 | 93.75 | 240 | 156.25 | 70 | 1,050 | 75 | 75 | 23 | 54 | 67 | 9.9 × 10¹² | 4 |
| Ex. 5 | | | | | | | | | | | | | | | |
| Comp. | 1.5 | — | 0 | 93.75 | — | 156.25 | 75 | 1,050 | 75 | — | 13 | 59 | 75 | 9.9 × 10¹² | 4 |
| Ex. 6 | | | | | | | | | | | | | | | |
| Ex. 7 | 1.5 | 30.24 | 60 | 15093.75 | 15120 | 15156.25 | 80 | 1,050 | 75 | 75 | 17 | 47 | 61 | 9.9 × 10¹² | 3 |
| Ex. 3 | 1.5 | 0.24 | 0 | 93.75 | 120 | 156.25 | 50 | 835 | 50 | 50 | 8 | 54 | 64 | 9.9 × 10¹² | 9 |
| Comp. | 1.5 | 0.12 | 0 | 93.75 | 60 | 156.25 | 51 | 835 | 50 | 50 | 16 | 50 | 55 | 9.9 × 10¹² | 10 |
| Ex. 7 | | | | | | | | | | | | | | | |
| Comp. | 1.5 | 0.48 | 0 | 93.75 | 240 | 156.25 | 50 | 835 | 50 | 50 | 20 | 57 | 66 | 9.9 × 10¹² | 10 |
| Ex. 8 | | | | | | | | | | | | | | | |
| Comp. | 1.5 | — | 0 | 93.75 | — | 156.25 | 50 | 835 | 50 | — | 13 | 63 | 75 | 9.9 × 10¹² | 12 |
| Ex. 9 | | | | | | | | | | | | | | | |
| Ex. 4 | 1.5 | 0.24 | 0 | 93.75 | 120 | 156.25 | 74 | 1,050 | 75 | 50 | 8 | 53 | 72 | 9.9 × 10¹² | 4 |
| Comp. | 1.5 | 0.12 | 0 | 93.75 | 60 | 156.25 | 77 | 1,050 | 75 | 50 | 16 | 50 | 64 | 9.9 × 10¹² | 3 |
| Ex. 10 | | | | | | | | | | | | | | | |
| Comp. | 1.5 | 0.48 | 0 | 93.75 | 240 | 156.25 | 71 | 1,050 | 75 | 50 | 19 | 57 | 72 | 9.9 × 10¹² | 4 |
| Ex. 11 | | | | | | | | | | | | | | | |
| Ex. 5 | 1.5 | 0.24 | 0 | 93.75 | 120 | 156.25 | 57 | 950 | 50 | 75 | 9 | 55 | 71 | 9.9 × 10¹² | 8 |
| Comp. | 1.5 | 0.12 | 0 | 93.75 | 60 | 156.25 | 60 | 950 | 50 | 75 | 16 | 51 | 64 | 9.9 × 10¹² | 9 |
| Ex. 12 | | | | | | | | | | | | | | | |
| Comp. | 1.5 | 0.48 | 0 | 93.75 | 240 | 156.25 | 54 | 950 | 50 | 75 | 20 | 58 | 72 | 9.9 × 10¹² | 9 |
| Ex. 13 | | | | | | | | | | | | | | | |

In Table 3-1, “A” is {(2m+1)×(λ1/4)}−{(λ1/4)×0.25}, “B” is {(2m+1)×(λ1/4)}+{(λ1/4)×0.25} and m is 60 for Examples 6 and 7 but is 0 for the other Examples and Comparative Examples.

TABLE 3-2

| | | | | | | | | Max. | 1^{st} | 2^{nd} | | | Visible | | |
|---|---|---|---|---|---|---|---|---|---|---|---|---|---|---|---|
| | Dielectric layer | | | | | | | re- | layer | layer | Visible | Solar | light | | |
| | | | | | Optical | | Peak | flec- | Peak | Peak | light | heat | ray | | Min. |
| | Re- | | | | thick- | | re- | tion | re- | re- | ray | gain | trans- | Surface | trans- |
| | frac- | | | | ness | | flec- | wave- | flec- | flec- | reflec- | coeffi- | mit- | resis- | mit- |
| | tive | | | | nd | | tance | length | tance | tance | tance | cient | tance | tance | tance |
| | index | nd/λ1 | m | A | (nm) | B | (%) | (nm) | (%) | (%) | (%) | (%) | (%) | (Ω/sq.) | (%) |
| Ex. 8 | 1.5 | 0.24 | 0 | 93.75 | 120 | 156.25 | 71 | 820 | 63 | 63 | 15 | 43 | 49 | 9.9 × 10¹² | 5 |
| Comp. | 1.5 | 0.12 | 0 | 93.75 | 60 | 156.25 | 64 | 820 | 63 | 63 | 24 | 41 | 40 | 9.9 × 10¹² | 7 |
| Ex. 14 | | | | | | | | | | | | | | | |
| Comp. | 1.5 | 0.48 | 0 | 93.75 | 240 | 156.25 | 73 | 820 | 63 | 63 | 32 | 42 | 50 | 9.9 × 10¹² | 5 |
| Ex. 15 | | | | | | | | | | | | | | | |
| Ex. 9 | 1.5 | 0.24 | 0 | 93.75 | 120 | 156.25 | 79 | 850 | 66 | 66 | 12 | 43 | 52 | 9.9 × 10¹² | 3 |
| Comp. | 1.5 | 0.12 | 0 | 93.75 | 60 | 156.25 | 78 | 850 | 66 | 66 | 24 | 38 | 40 | 9.9 × 10¹² | 3 |
| Ex. 16 | | | | | | | | | | | | | | | |
| Comp. | 1.5 | 0.48 | 0 | 93.75 | 240 | 156.25 | 79 | 850 | 66 | 66 | 34 | 45 | 54 | 9.9 × 10¹² | 3 |
| Ex. 17 | | | | | | | | | | | | | | | |
| Ex. 10 | 1.5 | 0.24 | 0 | 93.75 | 120 | 156.25 | 68 | 1,000 | 60 | 50 | 8 | 53 | 68 | 9.9 × 10¹² | 6 |
| Comp. | 1.5 | 0.12 | 0 | 93.75 | 60 | 156.25 | 74 | 1,000 | 60 | 50 | 16 | 48 | 60 | 9.9 × 10¹² | 5 |
| Ex. 18 | | | | | | | | | | | | | | | |
| Comp. | 1.5 | 0.48 | 0 | 93.75 | 240 | 156.25 | 62 | 1,000 | 60 | 50 | 20 | 56 | 69 | 9.9 × 10¹² | 7 |
| Ex. 19 | | | | | | | | | | | | | | | |
| Ex. 11 | 1.5 | 0.24 | 0 | 93.75 | 120 | 156.25 | 50 | 850 | 50 | 60 | 8 | 54 | 68 | 9.9 × 10¹² | 8 |
| Comp. | 1.5 | 0.12 | 0 | 93.75 | 60 | 156.25 | 54 | 850 | 50 | 60 | 16 | 50 | 60 | 9.9 × 10¹² | 8 |
| Ex. 20 | | | | | | | | | | | | | | | |
| Comp. | 1.5 | 0.48 | 0 | 93.75 | 240 | 156.25 | 49 | 850 | 50 | 60 | 21 | 56 | 69 | 9.9 × 10¹² | 8 |
| Ex. 21 | | | | | | | | | | | | | | | |
| Ex. 12 | 2 | 0.24 | 0 | 93.75 | 120 | 156.25 | 64 | 1,200 | 60 | 60 | 8 | 61 | 78 | 9.9 × 10¹² | 7 |
| Comp. | 2 | 0.32 | 0 | 93.75 | 160 | 156.25 | 62 | 1,200 | 60 | 60 | 11 | 63 | 79 | 9.9 × 10¹² | 7 |
| Ex. 22 | | | | | | | | | | | | | | | |
| Comp. | 2 | 0.16 | 0 | 93.75 | 80 | 156.25 | 64 | 1,200 | 60 | 60 | 10 | 59 | 75 | 9.9 × 10¹² | 7 |
| Ex. 23 | | | | | | | | | | | | | | | |
| Comp. | 2 | 0.48 | 0 | 93.75 | 240 | 156.25 | 58 | 1,200 | 60 | 60 | 18 | 64 | 74 | 9.9 × 10¹² | 8 |
| Ex. 24 | | | | | | | | | | | | | | | |
| Comp. | 2 | 0.64 | 0 | 93.75 | 320 | 156.25 | 54 | 1,200 | 60 | 60 | 11 | 63 | 72 | 9.9 × 10¹² | 8 |
| Ex. 25 | | | | | | | | | | | | | | | |
| Ex. 13 | 1.5 | 0.24 | 0 | 93.75 | 120 | 156.25 | 61 | 1,050 | 60 | 60 | 8 | 53 | 74 | 9.9 × 10¹² | 8 |
| Comp. | 1.5 | 0.12 | 0 | 93.75 | 60 | 156.25 | 60 | 1,050 | 60 | 60 | 15 | 48 | 64 | 9.9 × 10¹² | 8 |
| Ex. 26 | | | | | | | | | | | | | | | |
| Comp. | 1.5 | 0.48 | 0 | 93.75 | 240 | 156.25 | 56 | 1,050 | 60 | 60 | 20 | 58 | 72 | 9.9 × 10¹² | 8 |
| Ex. 27 | | | | | | | | | | | | | | | |
| Comp. | 1.5 | — | 0 | 93.75 | — | 156.25 | 60 | 1,050 | 60 | — | 11 | 62 | 79 | 9.9 × 10¹² | 9 |
| Ex. 28 | | | | | | | | | | | | | | | |
| Ex. 14 | 1.5 | 0.24 | 0 | 93.75 | 120 | 156.25 | 61 | 900 | 60 | 60 | 8 | 48 | 70 | 9.9 × 10¹² | 8 |
| Comp. | 1.5 | 0.48 | 0 | 93.75 | 240 | 156.25 | 60 | 900 | 60 | 60 | 15 | 50 | 71 | 9.9 × 10¹² | 8 |
| Ex. 29 | | | | | | | | | | | | | | | |
| Comp. | — | — | 0 | 93.75 | — | 156.25 | 56 | 900 | 60 | — | 10 | 55 | 75 | 9.9 × 10¹² | 9 |
| Ex. 30 | | | | | | | | | | | | | | | |

In Table 3-2, “A” is {(2m+1)×(λ1/4)}−{(λ1/4)×0.25} (m is 0) and “B” is {(2m+1)×(λ1/4)}+{(λ1/4)×0.25} (m is 0).

As is clear from Tables 1-1 to 3-2, when the optical thickness of the dielectric layer satisfies the above expression (1), the heat-ray shielding material has high reflection wavelength selectivity and reflection band selectivity and is excellent in visible light transmittance and radio wave transmittance.

From FIG. 6C showing the visible light transmission spectrum and heat ray reflection spectrum in Example 1, the visible light transmittance was 74.2%, the solar heat gain coefficient was 55.6%, the visible light reflectance was 9.8% and the visible light reflectance of the metal particle-containing layer was 3.1%. Meanwhile, from FIG. 6B showing the visible light transmission spectrum and heat ray reflection spectrum in Comparative Example 6, the visible light transmittance was 75.2%, the solar heat gain coefficient was 58.8%, the visible light reflectance was 14.6% and the visible light reflectance of the metal particle-containing layer was 8.2%, indicating that the visible light reflectance of the metal particle-containing layer was suppressed in addition to the visible light reflectance.

### Example 15

A heat-ray shielding material was produced in the same manner as in Example 1 except that a metal particle-containing layer (second layer), a dielectric layer (second layer) and a metal particle-containing layer (third layer) were formed in the below-described manner. The obtained heat-ray shielding materials and metal particles were evaluated for properties in the same manner as in Example 1. The results are shown in Tables 4-1 to 7.

### —Formation of a Metal Particle-Containing Layer (Second Layer)—

A dispersion liquid of flat silver particles was prepared in the same manner as in the above “Synthesis of flat metal particles.” Using the dispersion liquid of flat silver particles, hexagonal flat silver particles were fixed on the dielectric layer (first layer) of SiO₂ in the same manner as in the above “Formation of a metal particle-containing layer (first layer)” to thereby form a metal particle-containing layer (second layer).

### —Formation of a Dielectric Layer (Second Layer)—

A dielectric layer was formed on the metal particle-containing layer (second layer) by vapor-depositing SiO₂ through electron beam vapor deposition (using EBX-8C, product of ULVAC, Inc.). In this vapor deposition, the thickness of the SiO₂ layer was adjusted to 80 nm based on the value of a quartz crystal unit (product of ULVAC TECHNO Inc., gold 5 MHz_CR5G1).

### —Formation of a Metal Particle-Containing Layer (Third Layer)—

A dispersion liquid of flat silver particles was prepared in the same manner as in the above “Synthesis of flat metal particles.” Using the dispersion liquid of flat silver particles, hexagonal flat silver particles were fixed on the dielectric layer (second layer) of SiO₂ in the same manner as in the above “Formation of a metal particle-containing layer (second layer)” to thereby form a metal particle-containing layer (third layer).

A carbon thin film was formed by vapor deposition on the formed metal particle-containing layer (third layer) so as to have a thickness of 20 nm. When the resultant film was observed under the SEM, the hexagonal flat silver particles were fixed on the dielectric layer without aggregation. Through the above procedure, a heat-ray shielding material of Example 1 was produced.

### Comparative Examples 31 and 32

Heat-ray shielding materials were produced in the same manner as in Example 15 except that the thickness of the dielectric layer of SiO₂ vapor-deposited was changed as shown in Tables 4-1 to 4-3. The obtained heat-ray shielding materials and metal particles were evaluated for properties in the same manner as in Example 1. The results are shown in Tables 4-1 to 7.

TABLE 4-1

| | Metal particle-containing layer (first layer) | | | | | |
|---|---|---|---|---|---|---|
| | | Rate | | | | Coefficient |
| | | of flat | Avg. | Avg. | | of variation |
| | | particles | circle-eq. | thick- | | of particle |
| | | (% by | diameter | ness | Aspect | size |
| | Shape | number) | (nm) | (nm) | ratio | distribution |
| Ex. 15 | Substantially | 91 | 170 | 10 | 17.0 | 8% |
| | disc-shaped | | | | | |
| Comp. | Substantially | 91 | 170 | 10 | 17.0 | 8% |
| Ex. 31 | disc-shaped | | | | | |
| Comp. | Substantially | 91 | 170 | 10 | 17.0 | 8% |
| Ex. 32 | disc-shaped | | | | | |

TABLE 4-2

| | Metal particle-containing layer (second layer) | | | | | |
|---|---|---|---|---|---|---|
| | | Rate | | | | Coefficient |
| | | of flat | Avg. | Avg. | | of variation |
| | | particles | circle-eq. | thick- | | of particle |
| | | (% by | diameter | ness | Aspect | size |
| | Shape | number) | (nm) | (nm) | ratio | distribution |
| Ex. 15 | Substantially | 91 | 170 | 10 | 17.0 | 8% |
| | disc-shaped | | | | | |
| Comp. | Substantially | 91 | 170 | 10 | 17.0 | 8% |
| Ex. 31 | disc-shaped | | | | | |
| Comp. | Substantially | 91 | 170 | 10 | 17.0 | 8% |
| Ex. 32 | disc-shaped | | | | | |

TABLE 4-3

| | Metal particle-containing layer (third layer) | | | | | |
|---|---|---|---|---|---|---|
| | | Rate | | | | Coefficient |
| | | of flat | Avg. | Avg. | | of variation |
| | | particles | circle-eq. | thick- | | of particle |
| | | (% by | diameter | ness | Aspect | size |
| | Shape | number) | (nm) | (nm) | ratio | distribution |
| Ex. 15 | Substantially | 91 | 170 | 10 | 17.0 | 8% |
| | disc-shaped | | | | | |
| Comp. | Substantially | 91 | 170 | 10 | 17.0 | 8% |
| Ex. 31 | disc-shaped | | | | | |
| Comp. | Substantially | 91 | 170 | 10 | 17.0 | 8% |
| Ex. 32 | disc-shaped | | | | | |

TABLE 5-1

| | Metal particle-containing layer | | | | Metal particle-containing layer | | | | Thick- |
|---|---|---|---|---|---|---|---|---|---|
| | (first layer) | | | | (second layer) | | | | ness |
| | Avg. | | | | Avg. | | | | d of |
| | circle-eq. | Avg. | | | circle-eq. | Avg. | | | dielectric |
| | diameter | thickness | Amount | | diameter | thickness | Amount | | layer |
| | of metal | of metal | of water | Area | of metal | of metal | of water | Area | (first |
| | particles | particles | used | ratio | particles | particles | used | ratio | layer) |
| | (nm) | (nm) | (mL) | (%) | (nm) | (nm) | (mL) | (%) | (nm) |
| Ex. 15 | 170 | 10 | 6 | 41 | 170 | 10 | 6 | 41 | 80 |
| Comp. | | | | | | | | | |
| Ex. 31 | 170 | 10 | 6 | 41 | 170 | 10 | 6 | 41 | 40 |
| Comp. | | | | | | | | | |
| Ex. 32 | 170 | 10 | 6 | 41 | 170 | 10 | 6 | 41 | 160 |

TABLE 5-2

| | Metal particle-containing layer | | | | Metal particle-containing layer | | | | Thick- |
|---|---|---|---|---|---|---|---|---|---|
| | (second layer) | | | | (third layer) | | | | ness |
| | Avg. | | | | Avg. | | | | d of |
| | circle-eq. | Avg. | | | circle-eq. | Avg. | | | dielectric |
| | diameter | thickness | Amount | | diameter | thickness | Amount | | layer |
| | of metal | of metal | of water | Area | of metal | of metal | of water | Area | (second |
| | particles | particles | used | ratio | particles | particles | used | ratio | layer) |
| | (nm) | (nm) | (mL) | (%) | (nm) | (nm) | (mL) | (%) | (nm) |
| Ex. 15 | 170 | 10 | 6 | 41 | 170 | 10 | 6 | 41 | 80 |
| Comp. | 170 | 10 | 6 | 41 | 170 | 10 | 6 | 41 | 40 |
| Ex. 31 | | | | | | | | | |
| Comp. | 170 | 10 | 6 | 41 | 170 | 10 | 6 | 41 | 160 |
| Ex. 32 | | | | | | | | | |

TABLE 6

| | Dielectric layer (first layer) | | | | | | Dielectric layer (second layer) | | | | | |
|---|---|---|---|---|---|---|---|---|---|---|---|---|
| | | | | | Optical | | | | | | Optical | |
| | | | | | thick- | | | | | | thick- | |
| | Refrac- | | | | ness | | Refrac- | | | | ness | |
| | tive | | | | nd | | tive | | | | nd | |
| | index | nd/λ1 | m | A | (nm) | B | index | nd/λ1 | m | A | (nm) | B |
| Ex. 15 | 1.5 | 0.24 | 0 | 93.75 | 120 | 156.25 | 1.5 | 0.24 | 0 | 93.75 | 120 | 156.25 |
| Comp. | 1.5 | 0.12 | 0 | 93.75 | 60 | 156.25 | 1.5 | 0.12 | 0 | 93.75 | 60 | 156.25 |
| Ex. 31 | | | | | | | | | | | | |
| Comp. | 1.5 | 0.48 | 0 | 93.75 | 240 | 156.25 | 1.5 | 0.48 | 0 | 93.75 | 240 | 156.25 |
| Ex. 32 | | | | | | | | | | | | |

In Table 6, “A” is {(2m + 1) × (λ1/4)} − {(λ1/4) × 0.25} (m is 0) and “B” is {(2m + 1) × (λ1/4)} + {(λ1/4) × 0.25} (m is 0).

TABLE 7

| | | Max. | 1^{st} | 2^{nd} | 3^{rd} | Visible | Solar | | | |
|---|---|---|---|---|---|---|---|---|---|---|
| | | reflec- | layer | layer | layer | light | heat | Visible | | |
| | Peak | tion | Peak | Peak | Peak | ray | gain | light ray | Surface | Min. |
| | reflec- | wave- | reflec- | reflec- | reflec- | reflec- | coeffi- | transmit- | resis- | transmit- |
| | tance | length | tance | tance | tance | tance | cient | tance | tance | tance |
| | (%) | (nm) | (%) | (%) | (%) | (%) | (%) | (%) | (Ω/sq.) | (%) |
| Ex. 15 | 66 | 1,050 | 60 | 60 | 60 | 8 | 53 | 74 | 9.9 × 10¹² | 2 |
| Comp. | 63 | 1,050 | 60 | 60 | 60 | 15 | 48 | 64 | 9.9 × 10¹² | 3 |
| Ex. 31 | | | | | | | | | | |
| Comp. | 56 | 1,050 | 60 | 60 | 60 | 20 | 58 | 72 | 9.9 × 10¹² | 4 |
| Ex. 32 | | | | | | | | | | |

As is clear from Tables 4-1 to 7, when the optical thickness of the dielectric layer satisfies the above expression (1), the heat-ray shielding material has high reflection wavelength selectivity and reflection band selectivity and is excellent in visible light transmittance and radio wave transmittance.

### INDUSTRIAL APPLICABILITY

The heat ray-shielding material of the present invention is excellent in reflectance with respect to infrared rays such as near-infrared rays and excellent in transmittance with respect to visible light and radio waves. Thus, it can be suitably used as various members required for shielding heat rays, such as glass of vehicles (e.g., automobiles and buses) and building glass.

### REFERENCE SINGS LIST

1: Substrate
2: Metal particle-containing layer
3: Flat metal particles
4: Dielectric layer

1. A heat-ray shielding material comprising:
two or more metal particle-containing layers each containing at least one kind of metal particles; and
one or more transparent dielectric layers,
the heat-ray shielding material having a lamination structure where the metal particle-containing layers and the dielectric layers are alternatingly laminated,
wherein at least one of the transparent dielectric layers has an optical thickness (nd) which satisfies the following expression (1) with respect to wavelength λ1 at which reflectance of the transparent dielectric layer is minimum:
{(2m+1)×(λ1/4)}−{(λ1/4)×0.25}<nd<{(2m+1)×(λ1/4)}+{(λ1/4)×0.25} Expression (1)
where m is an integer of 0 or greater, λ1 is a wavelength at which the reflectance is minimum, n is a refractive index of the dielectric layer and d is a thickness (nm) of the dielectric layer.

2. The heat-ray shielding material according to claim 1, wherein the metal particles contain flat metal particles each having a substantially hexagonal shape or a substantially disc shape or both thereof in an amount of 60% by number or more.

3. The heat-ray shielding material according to claim 1, wherein among the two or more metal particle-containing layers, the metal particle-containing layer closest to a surface of the heat-ray shielding material through which solar radiation enters has the highest reflectance.

4. The heat-ray shielding material according to claim 1, wherein m in the expression (1) is 0.

5. The heat-ray shielding material according to claim 1, wherein the metal particles contain at least silver.

6. The heat-ray shielding material according to claim 1, wherein the metal particles are coated with a high-refractive-index material.

7. The heat-ray shielding material according to claim 1, wherein the heat-ray shielding material has a solar heat gain coefficient of 70% or lower.

8. The heat-ray shielding material according to claim 1, wherein the wavelength λ1 at which the reflectance is minimum is 380 nm to 780 nm.

9. The heat-ray shielding material according to claim 1, wherein the metal particle-containing layer has the minimum transmittance at a wavelength of 600 nm to 2,000 nm.

10. The heat-ray shielding material according to claim 1, wherein the heat-ray shielding material has a transmittance of 60% or higher with respect to visible light rays.

11. The heat-ray shielding material according to claim 1, wherein the dielectric layer has a thickness of 5 nm to 5,000 nm.
